(19) United States
(12) Patent Application Publication
(10) Pub. No.: US 2025/0083446 A1
(43) Pub. Date: Mar. 13, 2025

(54) LIGHT-EMITTING DEVICE AND LIQUID EJECTING DEVICE

(71) Applicant: SEIKO EPSON CORPORATION, Tokyo (JP)

(72) Inventors: Jun YODA, SHIOJIRI-SHI (JP); Hidekazu KOBAYASHI, HARA-MURA (JP)

(21) Appl. No.: 18/825,596

(22) Filed: Sep. 5, 2024

(30) Foreign Application Priority Data
Sep. 8, 2023 (JP) 2023-145704

(51) Int. Cl. B41J 2/175; F21V 8/00

(52) U.S. Cl. CPC B41J 2/17566; B41J 2/17553; G02B 6/0021; B41J 2002/17573

(57) ABSTRACT

A light-emitting device includes a light source and a light-guiding member on which light emitted by the light source is incident and from which the light incident exits to an outside, wherein the light-guiding member includes a plate portion having a planar shape, a first hole provided in the plate portion, the first hole being a hole in which the light source is disposed, and a plurality of second holes provided in the plate portion, the plurality of second holes being located between the first hole and a peripheral edge of the light-guiding member in plan view of the plate portion, the plurality of second holes being provided at intervals along the peripheral edge, and the light source emits light toward a side surface of the first hole.

The present application is based on, and claims priority from JP Application Serial Number 2023-145704, filed Sep. 8, 2023, the disclosure of which is hereby incorporated by reference herein in its entirety.

### BACKGROUND

### 1. Technical Field

The present disclosure relates to a light-emitting device that emits light from a light source to the outside. The present disclosure also relates to a liquid ejecting device including the light-emitting device.

### 2. Related Art

JP-A-2013-254680 discloses a panel device having a configuration in which a light-emitting unit formed of a transparent material is disposed around a button member, and the light-emitting unit causes the periphery of the button member to emit light. In this panel device, a light source is provided at a substrate, and light emitted from the light source is incident on a side surface of a light-guiding member. The light incident on the light-guiding member exits from an upper surface of the light-guiding member toward the light-emitting unit, so that the light can be emitted in a relatively wide area.

There is a case in which uneven brightness is likely to be conspicuous in the light-emitting unit. It is conceivable to increase the number of light sources in order to suppress uneven brightness, which however leads to a cost increase of the device.

### SUMMARY

A light-emitting device according to the present disclosure for solving the above problem includes a light source and a light-guiding member on which light emitted by the light source is incident and from which the light incident exits to an outside, wherein the light-guiding member includes a plate portion having a planar shape, a first hole provided in the plate portion, the first hole being a hole in which the light source is disposed, and a plurality of second holes provided in the plate portion, the plurality of second holes being located between the first hole and a peripheral edge of the light-guiding member in plan view of the plate portion, the plurality of second holes being provided at intervals along the peripheral edge, and the light source emits light toward a side surface of the first hole.

Moreover, a liquid ejecting device according to the present disclosure includes a device main body including a liquid ejecting head configured to eject a liquid to a medium and a liquid accommodating unit configured to accommodate the liquid to be ejected from the liquid ejecting head, wherein the liquid accommodating unit includes a supplying port of the liquid and an opening and closing cover configured to be switched between a closed state in which the supplying port is covered and an open state in which the supplying port is exposed, and the light-emitting device is configured at the opening and closing cover and emits light in accordance with a remaining amount of the liquid accommodated in the liquid accommodating unit.

### BRIEF DESCRIPTION OF THE DRAWINGS

FIG. 1 is a perspective view of a printer.

FIG. 2 is a perspective view illustrating a modification example of the printer.

FIG. 3A is a perspective view of a cover unit.

FIG. 3B is a perspective view illustrating a modification example of the cover unit.

FIG. 3C is a perspective view illustrating a modification example of the cover unit.

FIG. 3D is a perspective view illustrating a modification example of the cover unit.

FIG. 3E is a perspective view illustrating a modification example of the cover unit.

FIG. 3F is a perspective view illustrating a modification example of the cover unit.

FIG. 3G is a perspective view illustrating a modification example of the cover unit.

FIG. 3H is a perspective view illustrating a modification example of the cover unit.

FIG. 4 is a perspective view of the printer in a state in which the cover unit is open.

FIG. 5 is a perspective view of an ink accommodating unit in a state in which the cover unit is open.

FIG. 6 is a cross-sectional perspective view of the ink accommodating unit taken along a Y-Z plane.

FIG. 7 is a perspective view of the cover unit viewed from a rear side.

FIG. 8A is a cross-sectional view of the ink accommodating unit taken along the Y-Z plane.

FIG. 8B is a cross-sectional view of the ink accommodating unit taken along the Y-Z plane.

FIG. 8C is a cross-sectional view of the ink accommodating unit taken along the Y-Z plane.

FIG. 9 is a perspective view of the printer in a state where a document cover is open.

FIG. 10 is a cross-sectional view of the ink

accommodating unit taken along the Y-Z plane.

FIG. 11 is a cross-sectional view of the ink accommodating unit taken along an X-Z plane.

FIG. 12 is a perspective view of the printer in a state in which the document cover is omitted from illustration.

FIG. 13 is a cross-sectional view of an operating panel taken along the Y-Z plane.

FIG. 14 is a plan view of the printer.

FIG. 15 is a plan view of the printer.

FIG. 16 is a side view of the printer.

FIG. 17 is an exploded perspective view of the cover unit.

FIG. 18 is a perspective view of a light-guiding member.

FIG. 19 is a perspective view of the light-guiding member.

FIG. 20 is a plan view of the light-guiding member and a substrate.

FIG. 21 is a perspective view of a light source and a first hole.

FIG. 22 is a view schematically illustrating how light travels inside the light-guiding member.

FIG. 23 is a view for describing arrangement of third holes.

FIG. 24 is a view schematically illustrating how light travels inside the light-guiding member.

FIG. 25 is a view for describing arrangement of the third holes.

FIG. 26 is a view schematically illustrating how light travels inside the light-guiding member.

FIG. 27 is a view schematically illustrating how light travels inside the light-guiding member.

FIG. 28 is a plan view of a light-guiding member and a substrate according to another embodiment.

FIG. 29 is a partial enlarged view of the light-guiding member according to the other embodiment.

### DESCRIPTION OF EMBODIMENTS

Hereinafter, the present disclosure will be schematically described.

A light-emitting device according to a first aspect includes a light source and a light-guiding member on which light emitted by the light source is incident and from which the light incident exits to an outside, wherein the light-guiding member includes a plate portion having a planar shape, a first hole provided in the plate portion, the first hole being a hole in which the light source is disposed, and a plurality of second holes provided in the plate portion, the plurality of second holes being located between the first hole and a peripheral edge of the light-guiding member in plan view of the plate portion, the plurality of second holes being provided at intervals along the peripheral edge, and the light source emits light toward a side surface of the first hole.

Since the light source emits light toward the side surface of the first hole, the light emitted from the light source is incident from the side surface of the first hole and travels toward the peripheral edge of the light-guiding member in plan view of the plate portion. The light traveling toward the peripheral edge of the light-guiding member exits from the outer surface of the light-guiding member. Thus, it is possible to visually recognize as if the outer surface of the light-guiding member emits light. Note that the peripheral edge of the light-guiding member may serve as the outer surface that emits light, or a part other than the peripheral edge may serve as the outer surface that emits light as a result of light being reflected by the peripheral edge. In this specification, the peripheral edge is an edge forming the outer shape of the light-guiding member when the plate portion is seen in plan view.

Here, in order for light to exit from the outer surface of the light-guiding member, the light needs to travel at an angle at which the light is not totally reflected with respect to the outer surface of the light-guiding member. Thus, when the amount of light totally reflected at a predetermined position of the outer surface of the light guiding member is larger than the amount of light not totally reflected, the brightness at the predetermined position decreases. On the other hand, when the amount of light not totally reflected at a predetermined position of the outer surface of the light guiding member is larger than the amount of light totally reflected, the brightness at the predetermined position increases. For this reason, the brightness may be uneven as a whole at the outer surface of the light-guiding member.

However, according to this aspect, since light incident from the side surface of the first hole is reflected by the side surfaces of the plurality of second holes, the light incident from the first hole travels in more directions. Thus, the ratio between the amount of light totally reflected by the outer surface of the light-guiding member and the amount of light not totally reflected is made uniform at the outer surface of the light-guiding member. As a result, it is possible to suppress uneven brightness when the light-guiding member emits light and obtain a favorable light emission state.

A second aspect is an aspect dependent on the first aspect. In the second aspect, the light-guiding member includes a third hole provided in the plate portion, the third hole being located between the first hole and the plurality of second holes in plan view of the plate portion, and, in plan view of the plate portion, a line connecting the light source and a first part of the peripheral edge is defined as a first straight line, a line that connects the light source and a second part of the peripheral edge and that is a straight line shorter than the first straight line is defined as a second straight line, and the third hole is provided at a position intersecting the second straight line.

In the light-guiding member, the brightness of the outer surface closer to the light source is likely to be higher than that of the outer surface farther from the light source, which causes uneven brightness.

However, according to this aspect, the third hole is provided at the position intersecting the second straight line, which is shorter than the first straight line. Thus, since light is diffused by being reflected or refracted at the side surface of the third hole, it is possible to suppress an increase in the brightness of the outer surface close to the light source and suppress uneven brightness.

In addition, it can be expected that light reflected by the side surface of the third hole returns to the first hole, is reflected by the side surface of the first hole, and travels toward the far outer surface.

A third aspect is an aspect dependent on the second aspect. In the third aspect, the light-guiding member includes a plurality of the third holes, and at least one of the plurality of third holes has an elliptical shape such that a clearance from the first hole and clearances from the plurality of second holes increase.

The third holes are to suppress the brightness of the outer surface close to the light source and thus are preferably as large as possible. However, in a case in which the clearances between the first hole and the third holes or the clearances between the second holes and the third holes are narrow, the fluidity of resin in a mold decreases when the light-guiding member is resin-molded, which is likely to cause a molding defect.

However, according to this aspect, since the at least one third hole has an elliptical shape so as to increase the clearance from the first hole and the clearances from the second holes, it is possible to suppress narrowing of the clearance between the first hole and the third hole and the clearances between the second holes and the third hole while widely reflecting light from the light source toward the outer surface close to the light source, and suppress the above-described molding defect.

A fourth aspect is an aspect dependent on the second aspect. In the fourth aspect, the light-guiding member includes a plurality of the third holes, and
at least one of the plurality of third holes has a shape obtained by cutting a part of a circle to have a chord and an arc, and the chord is disposed to face the first hole.

The third holes are to suppress the brightness of the outer surface close to the light source and thus are preferably as large as possible. However, in a case in which the clearances between the first hole and the third holes or the clearances between the second holes and the third holes are narrow, the fluidity of resin in a mold decreases when the light-guiding member is resin-molded, which is likely to cause a molding defect.

However, according to this aspect, since the at least one third hole has the shape obtained by cutting the part of the circle so as to have the chord and the arc, and the chord is disposed so as to face the first hole, it is possible to suppress narrowing of the clearance between the first hole and the third hole and the clearances between the second holes and the third hole while widely reflecting light from the light source toward the outer surface close to the light source, and suppress the above-described molding defect.

A fifth aspect is an aspect dependent on the second aspect. In the fifth aspect, the light-guiding member includes a plurality of the third holes, and at least one of the plurality of third holes is a hole having an area larger than the plurality of second holes and has a circular shape, an elliptical shape, or a closed curved shape.

Since the third holes are to suppress the brightness of the outer surface close to the light source, the third holes preferably have a certain size.

According to this aspect, the at least one third hole is a hole having an area larger than the plurality of second holes and has a circular shape, an elliptical shape, or a closed curved shape. Thus, light reflection at the side surface of the third hole is enabled and the brightness of the outer surface closer to the light source can be suitably suppressed.

Note that the above area means an area when the third hole is viewed in plan view.

A sixth aspect is an aspect dependent on the second aspect. In the sixth aspect, the light-guiding member includes a fourth hole provided in a center of the plate portion, the fourth hole forming an opening larger than the first hole, the plurality of second holes, and the third hole.

According to this aspect, the light-guiding member includes the fourth hole provided in the center of the plate portion, the fourth hole forming the opening larger than the first hole, the second holes, and the third hole. Thus, it can be expected that light reflected by the side surface of the third hole or the side surfaces of the second holes and returning toward the center of the plate portion is reflected at the side surface of the fourth hole and travels toward the outer surface far from the light source, that is, the outer surface the brightness of which is likely to decrease.

Note that this aspect may depend not only on the second aspect but also on any of the third to fifth aspects.

A seventh aspect is an aspect dependent on the first aspect. In the seventh aspect, the light-guiding member includes an outer wall portion forming the peripheral edge and standing in a direction intersecting a surface of the plate portion.

According to this aspect, the light-guiding member includes the outer wall portion forming the peripheral edge and standing in the direction intersecting the surface of the plate portion. Thus, light emitted by the light source exits from the outer wall portion, so that the emitted light can be visually recognized not only from the side but also from the above, which improves visibility.

Note that this aspect may depend not only on the first aspect but also on any of the second to sixth aspects.

An eighth aspect is an aspect dependent on the seventh aspect. In the eighth aspect, a groove portion is formed on an outside of the outer wall portion, the groove portion being configured to reflect light traveling toward an outside of the plate portion and guide the light to a top portion of the outer wall portion.

According to this aspect, the groove portion is formed on the outside of the outer wall portion, the groove portion being configured to reflect light traveling toward the outside of the plate portion and guide the light to the top portion of the outer wall portion. Thus, it is possible to obtain the brightness of the outer wall portion.

A ninth aspect is an aspect dependent on the seventh aspect. In the ninth aspect, a light-shielding member is provided inside the outer wall portion and above the plate portion, wherein the light-shielding member causes the outer wall portion to be configured to emit light in a ring shape.

According to this aspect, the light-shielding member is provided inside the outer wall portion and above the plate portion, and the light-shielding member causes the outer wall portion to be configured to emit light in a ring shape.

This makes uneven brightness less conspicuous than in a configuration in which the entire light-guiding member serves as a light-emitting part.

Note that this aspect may depend not only on the seventh aspect but also on the eighth aspect.

A tenth aspect is an aspect dependent on the first aspect. In the tenth aspect, a substrate is provided with the light source, wherein a surface, of the substrate, at which the light source is provided is formed as a reflection surface configured to reflect light.

According to the aspect, the surface of the substrate at which the light source is provided is formed as the reflection surface configured to reflect light. Thus, it is possible to suppress loss of light emitted from the light source and suitably cause the light to exit from the light-guiding member.

Note that this aspect may depend not only on the first aspect but also on any of the second to ninth aspects.

An eleventh aspect is an aspect dependent on the first aspect. In the eleventh aspect, provided are a substrate provided with the light source and a reflection sheet, the reflection sheet and the substrate being on opposite sides of the plate portion of the light-guiding member, the reflection sheet being configured to reflect light.

According to this aspect, the reflection sheet configured to reflect light and the substrate are on the opposite sides of the plate portion of the light-guiding member. Thus, it is possible to suppress loss of light emitted from the light source and suitably cause the light to exit from the light-guiding member.

Note that this aspect may depend not only on the first aspect but also on any of the second to tenth aspects.

A twelfth aspect is an aspect dependent on the first aspect. In the twelfth aspect, a filter is provided between an inner surface of the first hole and the light source, the filter being configured to adjust a light emission color.

According to this aspect, the filter configured to adjust the light emission color is provided between the inner surface of the first hole and the light source. Thus, the light emission color can be easily adjusted.

Note that this aspect may depend not only on the first aspect but also on any of the second to eleventh aspects.

A thirteenth aspect is an aspect dependent on the first aspect. In the thirteenth aspect, the light-guiding member is formed of an optically transparent material including a light-diffusing material.

According to this aspect, the light-guiding member is formed of the optically transparent material including the light-diffusing material. Thus, it is possible to blur light reflected inside the light-guiding member, and make the light look as if it is emitted uniformly.

Note that this aspect may depend not only on the first aspect but also on any of the second to twelfth aspects.

A fourteenth aspect is an aspect dependent on the first aspect. In the fourteenth aspect, a surface of the light-guiding member is subjected to embossing.

According to this aspect, the surface of the light-guiding member is subjected to embossing. Thus, it is possible to blur light reflected inside the light-guiding member, and make the light look as if it is emitted uniformly.

Note that this aspect may depend not only on the first aspect but also on any of the second to thirteenth aspects.

A liquid ejecting device according to a fifteenth aspect includes a device main body including a liquid ejecting head configured to eject a liquid to a medium and a liquid accommodating unit configured to accommodate the liquid to be ejected from the liquid ejecting head, wherein the liquid accommodating unit includes a supplying port of the liquid and an opening and closing cover configured to be switched between a closed state in which the supplying port is covered and an open state in which the supplying port is exposed, and the light-emitting device according to any of the first to fourteenth aspects is configured at the opening and closing cover and emits light in accordance with a remaining amount of the liquid accommodated in the liquid accommodating unit.

According to this aspect, in the liquid ejecting device ejecting the liquid to the medium, the operations and effects of any of the first to fourteenth aspects can be obtained.

Hereinafter, the present disclosure will be specifically described.

Note that, in each diagram, an X-axis direction is a device width direction, a −X direction is a right direction as viewed from a user when a device front surface faces the user, and a +X direction is a left direction as viewed from the user.

A Y-axis direction is a device depth direction, a +Y direction is a direction from a device rear surface to the device front surface, and a −Y direction is a direction from the device front surface to the device rear surface. Note that, in this embodiment, a surface at which an operating panel 15 is provided among device side surfaces, that is, a side surface in the +Y direction is the device front surface.

Further, a Z-axis direction is a vertical direction, a +Z direction is a vertically upward direction, and a −Z direction is a vertically downward direction.

### Overall Configuration of Printer

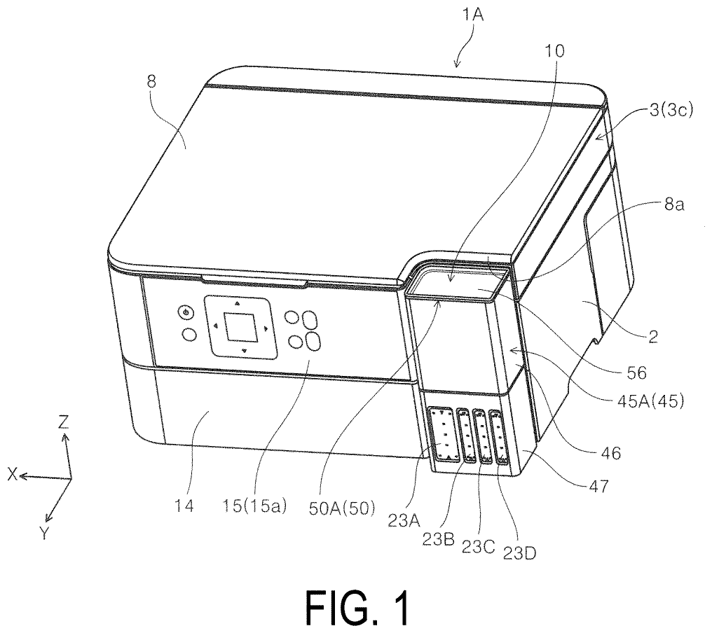

In FIG. 1, an inkjet printer 1A, which is an example of a liquid ejecting device, is a multifunction peripheral including a scanner unit 3, which is an example of a reading unit, at the top of a device main body 2. Hereinafter, the inkjet printer is abbreviated as a “printer”.

The device main body 2 has a box-like outer contour as a whole. The device main body 2 and the scanner unit 3 are configured to be substantially flush with each other at a side surface in the −X direction, that is, a right side surface, and a side surface in the +X direction, that is, a left side surface. Note that the right side surfaces and the left side surfaces of the device main body 2 and the scanner unit 3 are surfaces parallel to a Y-Z plane.

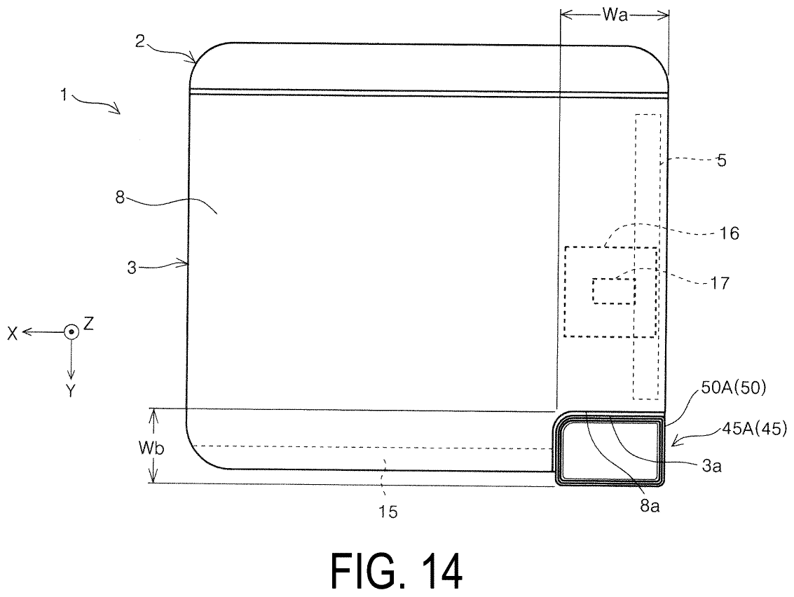

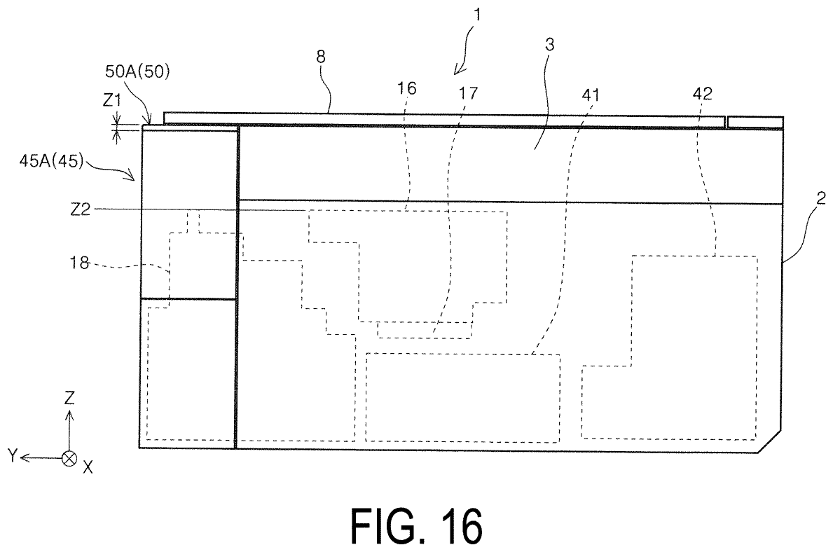

The device main body 2 has a function of performing recording on a medium represented by recording paper, and the scanner unit 3 has a function of reading a document. The device main body 2 includes an ink ejecting head 17 (see FIGS. 14 and 16) that ejects ink, which is an example of a liquid, to a medium. The ink ejecting head 17 is provided at a carriage 16 (see FIGS. 14 and 16) that moves in the X-axis direction, that is, a medium width direction. Ink is supplied to the ink ejecting head 17 from an ink accommodating unit 10, which is an example of a liquid accommodating unit described below, through an ink tube (not illustrated).

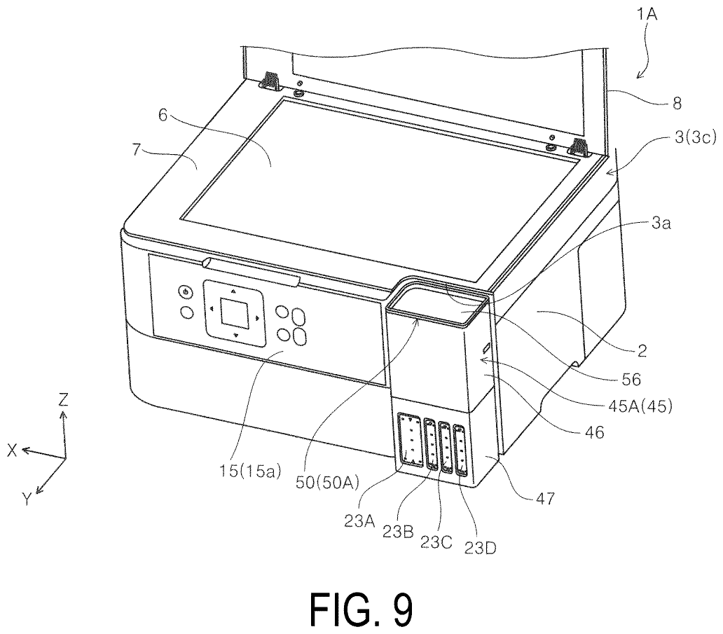

The scanner unit 3 includes, in a unit main body 3c, a reading sensor 5 (see FIG. 14) extending in the Y-axis direction. The reading sensor 5, which is an example of a reader that reads a document, includes a contact image sensor (CIS) in this embodiment, and reads a document placed at a document table 6 (see FIG. 9) while moving in the X-axis direction. The document table 6 is formed of glass, as an example.

A document cover 8 capable of opening and closing the document table 6 is provided at the top of the document table 6. The document cover 8 is coupled to the unit main body 3c of the scanner unit 3 via a hinge (not illustrated) provided at the rear of the device. The rotation axis of the document cover 8 is parallel to the X-axis direction, and the document cover 8 rotates with the +Y direction, that is, the front of the device as a free end, thereby opening and closing the document table 6.

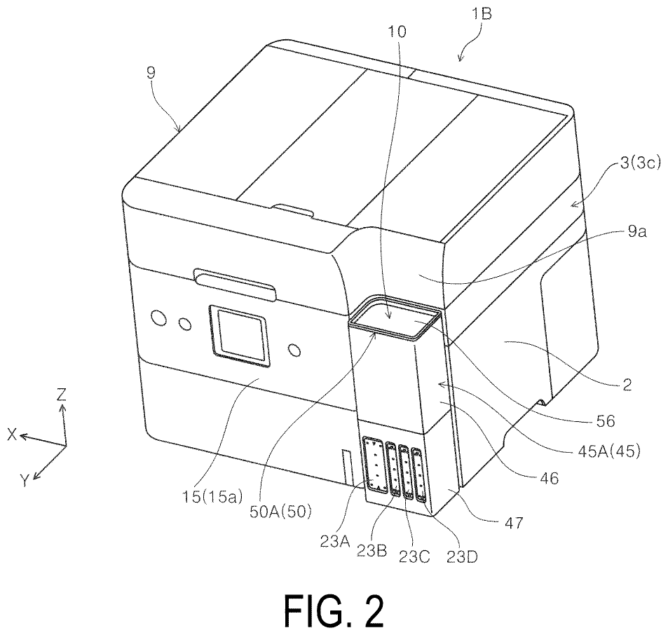

Note that, instead of the document cover 8, a document feeding device for automatically feeding a set document may be provided. A printer 1B illustrated in FIG. 2 has such a configuration and includes a document feeding device 9 instead of the document cover 8 described above. The document feeding device 9 is rotatably coupled to the scanner unit 3 via a hinge (not illustrated) provided at the rear of the device in a manner similar to the document cover 8 described above. The rotation axis of the document feeding device 9 is parallel to the X-axis direction, and the document feeding device 9 rotates with the +Y direction, that is, the front of the device as a free end, thereby opening and closing the document table 6.

When a document is read by using the document feeding device 9, the reading sensor 5 (see FIG. 14) reads the conveyed document in a state of being stopped at an end portion in the +X direction with respect to the document table 6. Note that, in this case, a first surface of the document is read by the reading sensor 5 (see FIG. 14), and a second surface opposite to the first surface is read by a reading sensor (not illustrated) provided inside the document feeding device 9. Note that a configuration may be adopted in which only the reading sensor 5 is provided, an inversion path for inverting the document is provided, and the document is inverted by the inversion path and read by the reading sensor 5, so that the first surface and the second surface of the document are read.

Note that the basic configurations of the device main body 2 and the unit main body 3c constituting the scanner unit 3 are the same between the printer 1A and the printer 1B.

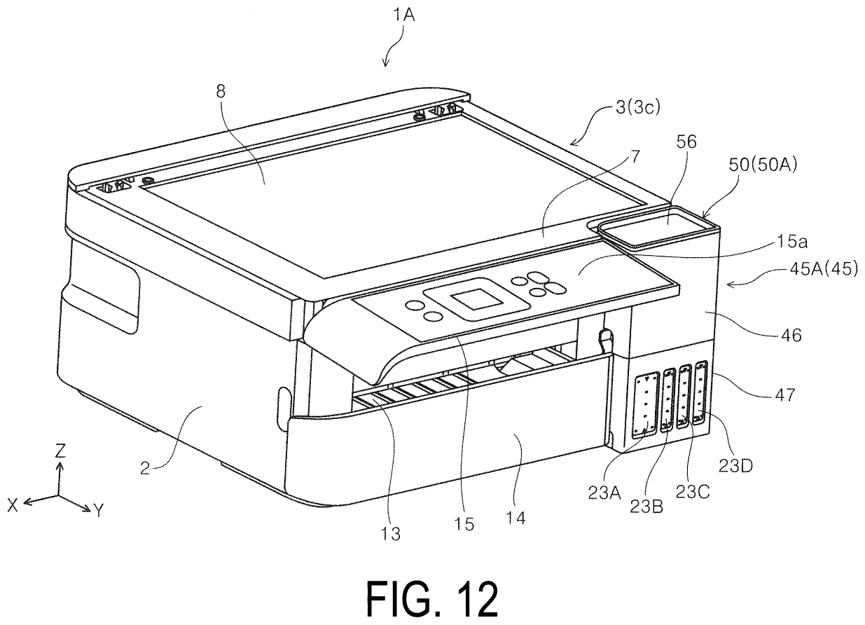

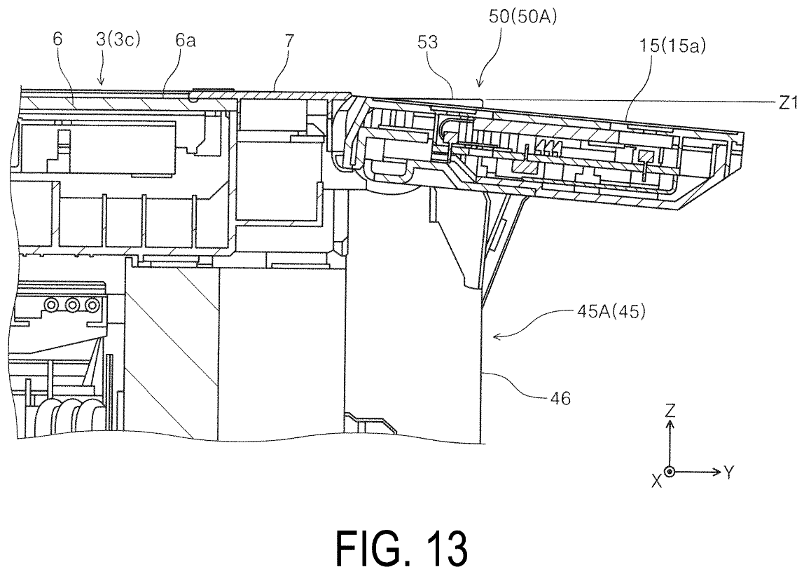

Referring back to FIG. 1, the operating panel 15 for performing various operation settings is provided at the device front surface. The operating panel 15 is tiltable and rotatable between a first state illustrated in FIG. 1 and a second state (see FIGS. 12 and 13) in which a panel surface 15a serving as a front surface is oriented in a more vertically upward direction than in the first state. Note that, in this embodiment, the panel surface 15a in the second state is tilted slightly downward and forms a predetermined angle with respect to a horizontal plane. However, the panel surface 15a in the second state may be parallel to the horizontal plane.

In FIG. 1, a front surface cover 14 is provided below the operating panel 15. The front surface cover 14 is provided in an openable and closable manner and can have a closed state (FIG. 1) and an open state (not illustrated). When the front surface cover 14 is opened, a discharging tray 13 (see FIG. 12) for receiving a medium that has been subjected to recording and discharged is exposed.

Note that the front surface cover 14 is provided rotatably with respect to a medium accommodating cassette (not illustrated). A medium accommodated in the medium accommodating cassette is sent in the −Y direction by a feeding roller (not illustrated), inverted, subjected to recording while being conveyed in the +Y direction, and discharged in the +Y direction. The front surface cover 14 in the closed state and the operating panel 15 in the first state are flush with each other as illustrated in FIG. 1.

Next, the ink accommodating unit 10, which is an example of a liquid accommodating unit, is provided in the −X direction, that is, on the right side, at the front surface of the device main body 2.

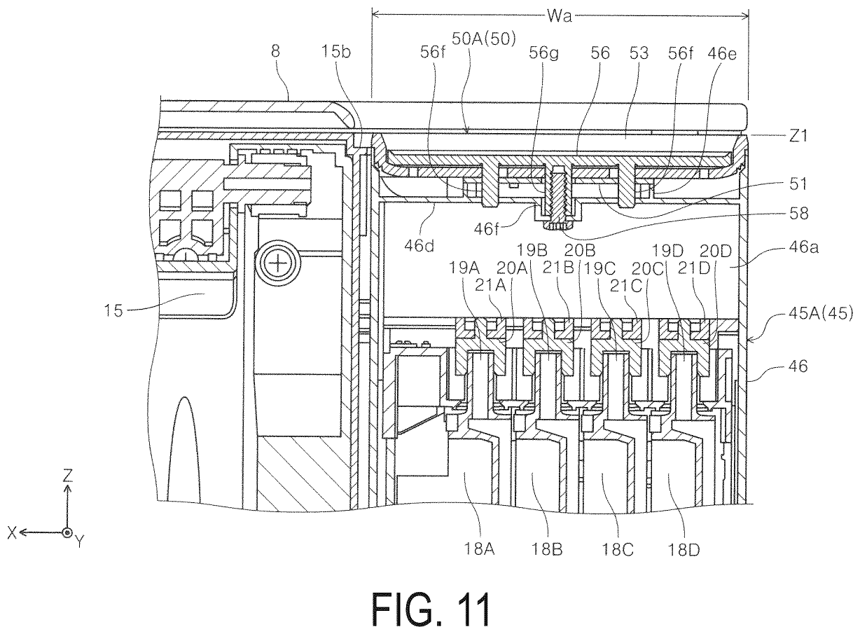

Ink tanks 18A, 18B, 18C, and 18D (see FIG. 11) as liquid accommodating containers are provided inside the ink accommodating unit 10. Note that when the ink tanks 18A, 18B, 18C, and 18D are not distinguished, they are hereinafter collectively referred to as ink tanks 18. The ink tanks 18 constitute the ink accommodating unit 10.

As an example, the ink tank 18A accommodates black ink, and the ink tanks 18B, 18C, and 18D accommodate color inks, for example, yellow, magenta, and cyan inks, respectively.

As illustrated in FIG. 1, the ink tanks 18 are provided inside an exterior member 47. Opening portions are provided at a front surface of the exterior member 47, and thus remaining amount visual recognition portions 23A, 23B, 23C, and 23D for visual recognition of the remaining ink amounts are exposed at the device front surface.

The remaining amount visual recognition portions 23A, 23B, 23C, and 23D are parts of the ink tanks 18A, 18B, 18C, and 18D, respectively. That is, the ink tanks 18A, 18B, 18C, and 18D are partially formed to be transparent or semitransparent so that the insides thereof can be visually recognized, and these parts serve as the remaining amount visual recognition portions 23A, 23B, 23C, and 23D. Note that when it is not necessary to distinguish the remaining amount visual recognition portions 23A, 23B, 23C, and 23D, they are collectively referred to as remaining amount visual recognition portions 23.

Note that a side surface of the exterior member 47 in the −X direction is flush with the side surfaces of the device main body 2 and the scanner unit 3 in the −X direction.

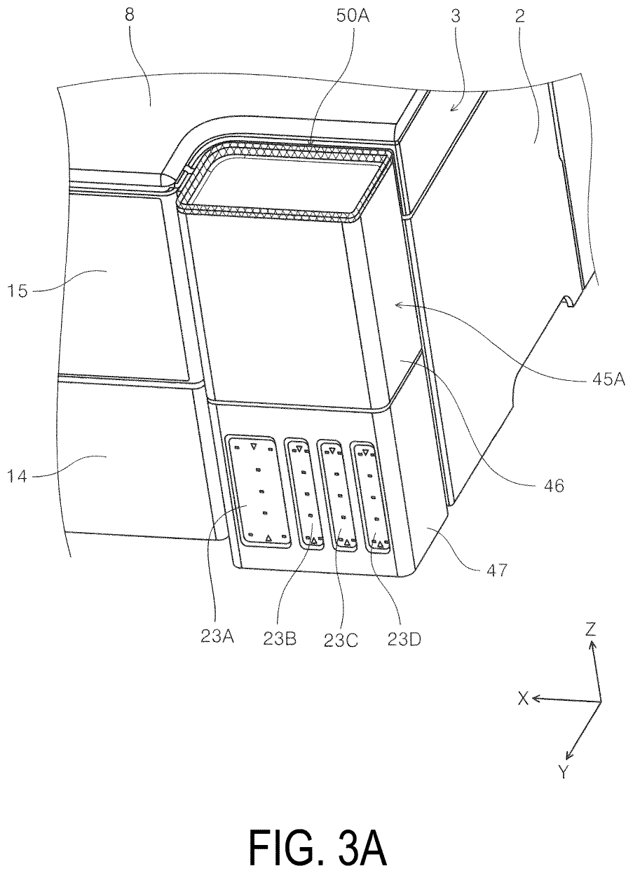

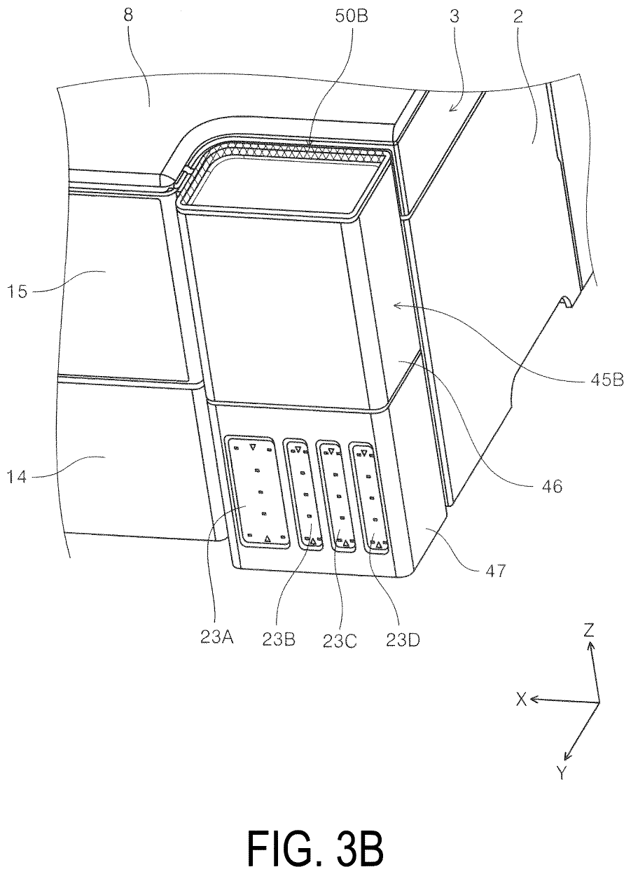

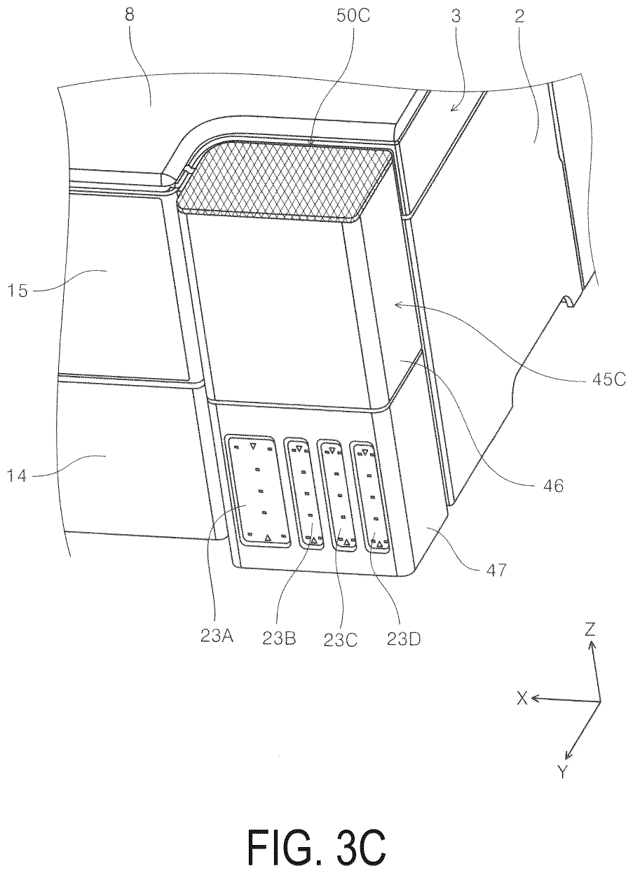

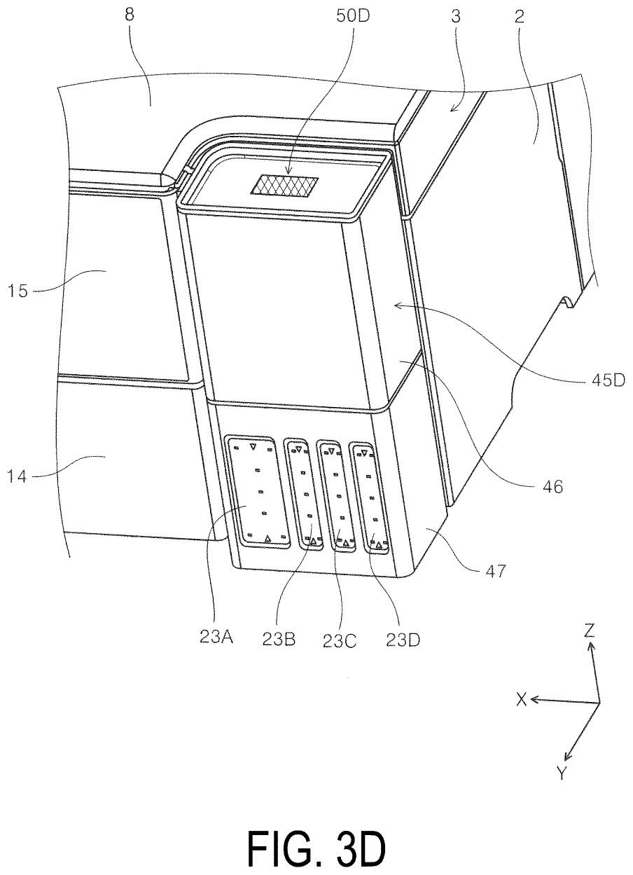

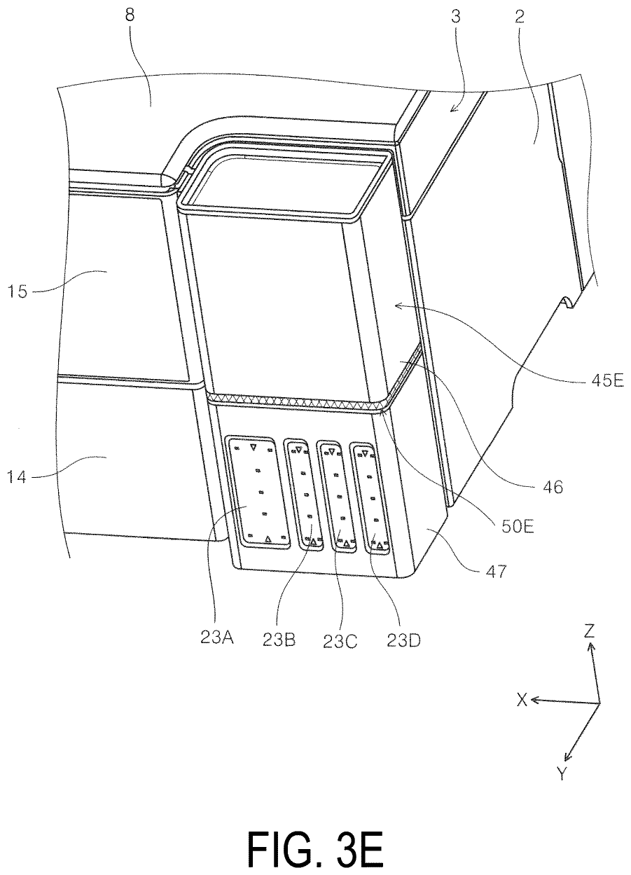

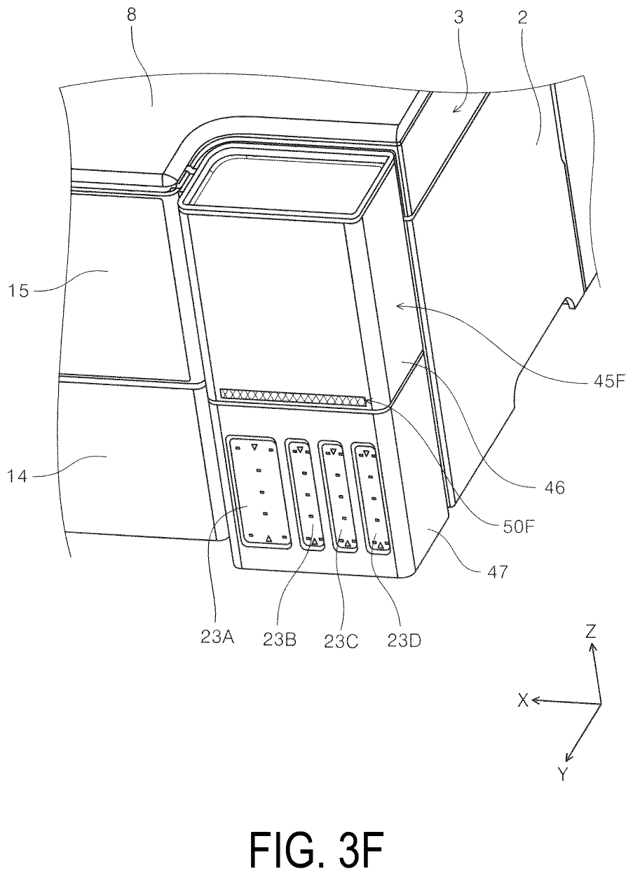

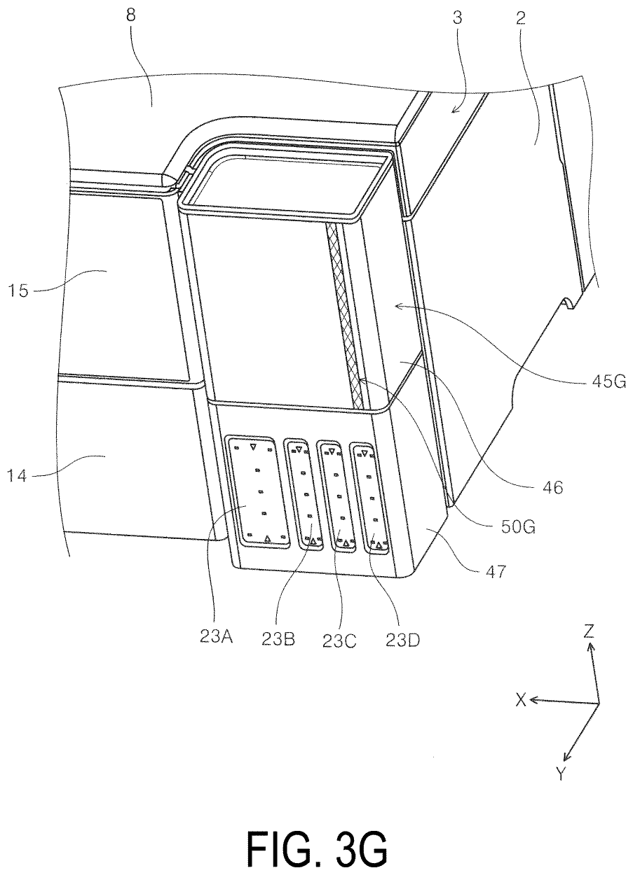

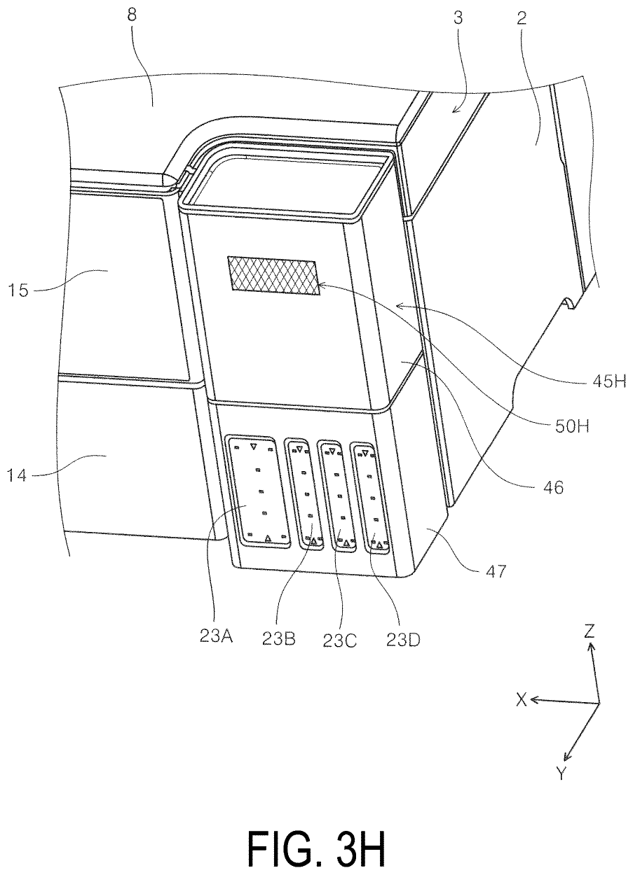

A cover unit 45A is provided above the exterior member 47. Note that there are a plurality of examples of the cover unit as described below with reference to FIGS. 3A to 3H. When it is not necessary to distinguish these examples of the cover unit, they are hereinafter collectively referred to as cover units 45. The cover unit 45 is an example of an opening and closing cover.

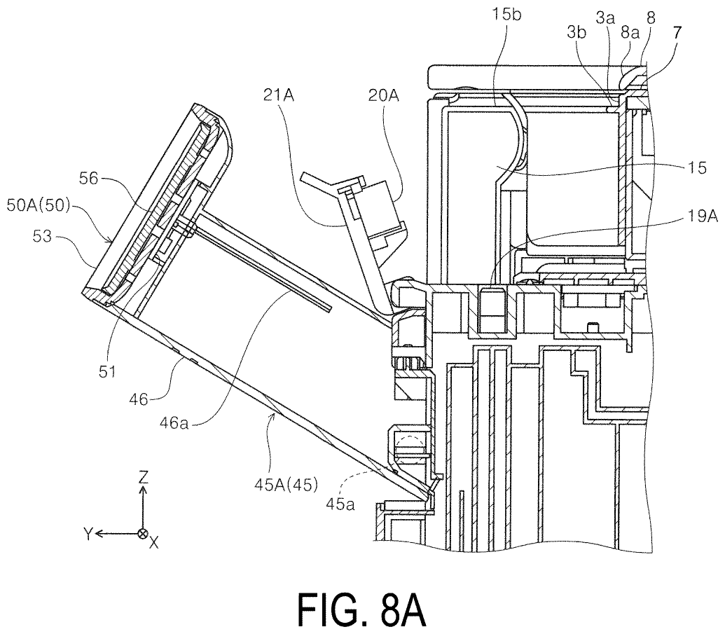

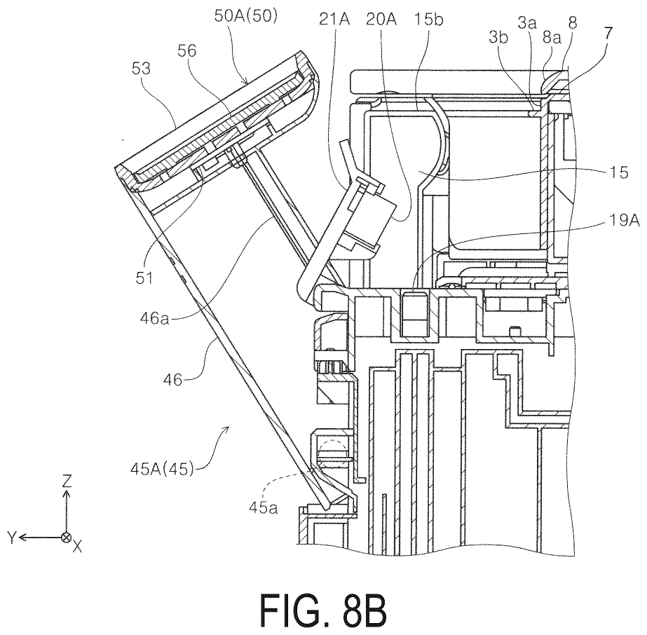

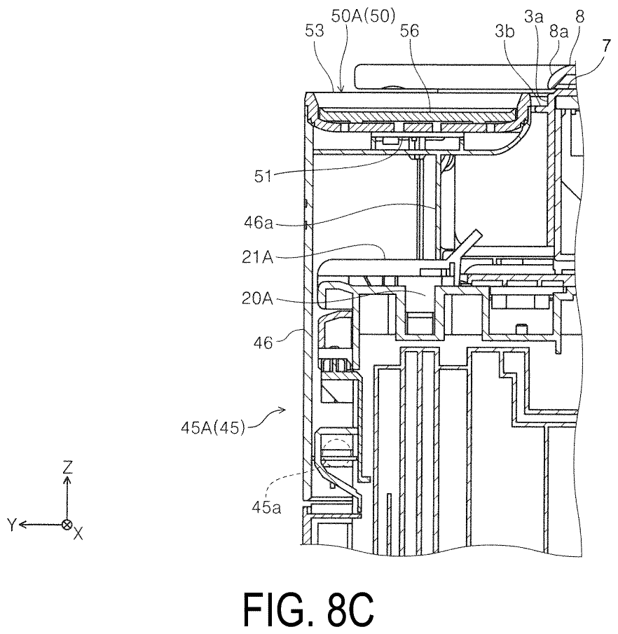

The cover unit 45 includes a cover member 46 as a base. The cover member 46, that is, the cover unit 45 is provided rotatably around a rotary shaft 45a (FIGS. 8A to 8C) provided at a lower portion and can have a closed state (FIGS. 1 and 8C) and a fully opened state (FIG. 8A) by rotating. In this embodiment, an axial center line of the rotary shaft 45a is parallel to the X-axis. The cover member 46, that is, the cover unit 45, according to this embodiment is provided in a manner attachable to and detachable from the rotary shaft 45a. However, the cover member 46, that is, the cover unit 45 may be fixedly provided at the rotary shaft 45a.

Note that a side surface of the cover unit 45 in the −X direction is flush with the side surfaces of the device main body 2 and the scanner unit 3 in the −X direction.

A side surface of the cover unit 45 in the +Y direction, that is, a front surface thereof is flush with the side surface of the exterior member 47 in the +Y direction, that is, the front surface thereof.

As indicated by a change from FIG. 1 to FIG. 4 or a change from FIG. 8C to FIG. 8A, the cover unit 45 includes an upper end portion as a free end, and the cover unit 45 in the closed state is opened by rotating toward the front of the device. Note that the cover unit 45 is configured to have the maximum opening angle smaller than 90° (see also FIG. 8A) and not to hinder the remaining amount visual recognition portions 23A, 23B, 23C, and 23D from being visually recognized even when the cover unit 45 is fully opened.

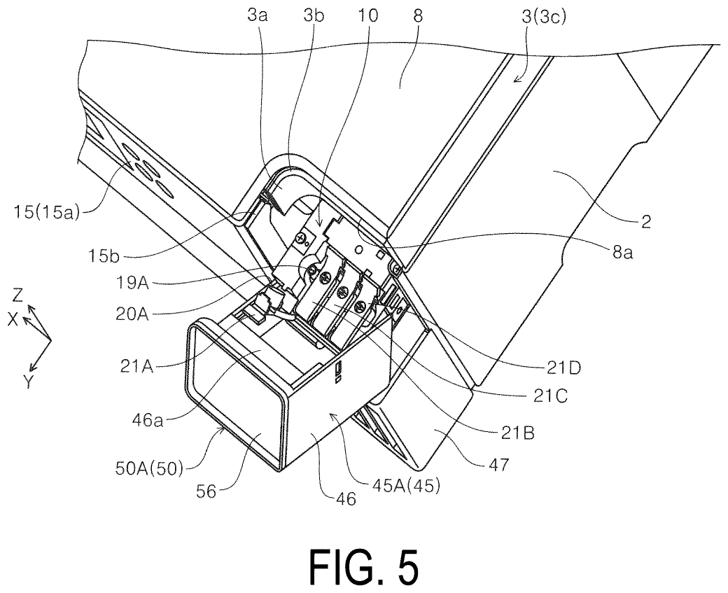

When the cover unit 45 is open, opening and closing levers 21A, 21B, 21C, and 21D are exposed as illustrated in FIG. 5. FIG. 5 illustrates a state in which the opening and closing levers 21B, 21C, 21D are closed and the opening and closing lever 21A is open. Note that when it is not necessary to distinguish the opening and closing levers 21A, 21B, 21C, and 21D, they are hereinafter collectively referred to as opening and closing levers 21.

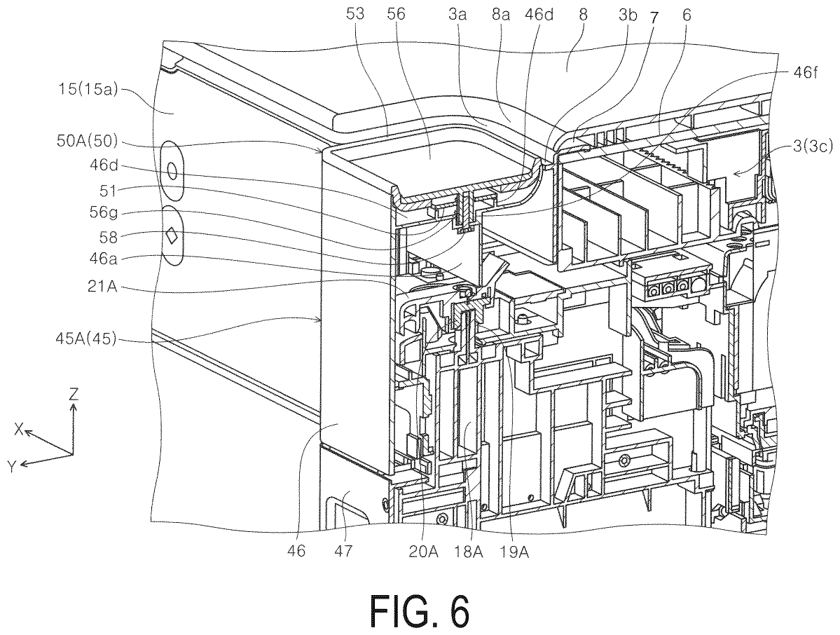

For example, the opening and closing lever 21A is provided with a sealing cap 20A. As illustrated in FIGS. 5 and 6, the ink tank 18A is provided with an ink supplying port 19A, and the ink supplying port 19A is exposed by opening the opening and closing lever 21A. The sealing cap 20A is made of an elastic material and closes the ink supplying port 19A when the opening and closing lever 21A is closed.

The user can refill the ink tank 18A with ink through the ink supplying port 19A by opening the opening and closing lever 21A and setting an ink refilling bottle (not illustrated) at the ink supplying port 19A.

Note that the other ink tanks 18B, 18C and 18D are similarly provided with ink supplying ports 19B, 19C and 19D, respectively, as illustrated in FIG. 11. The opening and closing levers 21B, 21C, and 21D are similarly provided with sealing caps 20B, 20C, and 20D, respectively.

Next, a part of an outer surface of the cover unit 45 emits light. The light emission of the cover unit 45 is controlled by a control unit (not illustrated) in accordance with the remaining ink amounts. As an example, when each of the remaining ink amounts is sufficient, the cover unit 45 does not emit light. When the end of the remaining ink amount is near, that is, the remaining ink amount is close to zero, or in the case of the end of the remaining ink amount, that is, when the remaining ink amount is zero, the cover unit 45 emits light. The light emission includes lighting and blinking, and may be either lighting or blinking or a combination of lighting and blinking. The control unit (not illustrated) adds up the amount of ink ejected from the ink ejecting head 17 (see FIGS. 14 and 16) to determine the remaining ink amount in each ink tank 18 and causes a part of the cover unit 45 to emit light as necessary.

### Examples of Light-Emitting Part of Cover Unit

The internal structure of the cover unit 45 will be described in detail below. Here, examples of a light-emitting part of the cover unit 45 will be described with reference to FIGS. 3A to 3H. Note that the light-emitting part is hatched in FIGS. 3A to 3H.

In the cover unit 45A illustrated in FIG. 3A, a light-emitting unit 50A is provided at an upper end portion of the cover unit 45A. The upper end portion of the cover unit 45A is in a state in which the inside of an outer peripheral portion is recessed and thus the outer peripheral portion protrudes upward. This will be described in detail below. The outer peripheral portion protruding upward at the upper end portion of the cover unit 45A is configured as the light-emitting unit 50A that emits light. That is, the light-emitting unit 50A emits light in a ring shape.

Note that, in addition to the light-emitting unit 50A according to this embodiment, light-emitting units 50A to 50H will be described below. When it is not necessary to distinguish the light-emitting units 50A to 50H, they are hereinafter collectively referred to as light-emitting units 50. In this embodiment, the light-emitting unit means a part that emits light.

According to this embodiment, the light-emitting unit 50A is provided at the upper end portion of the cover unit 45A, which improves the visibility of the light-emitting unit 50A.

In addition, in this embodiment, the light-emitting unit 50A is provided along the outer periphery of the cover unit 45A at the upper end portion of the cover unit 45A and emits light in a ring shape. Thus, it is possible to obtain the length of a region in which the light-emitting unit 50A emits light and improve the visibility of the light-emitting unit 50A.

In addition, in the cover unit 45A, a region inside the light-emitting unit 50A is recessed. This makes the light-emitting unit 50A more conspicuous and improves the visibility of the light-emitting unit 50A.

In addition, when the cover unit 45A is opened and closed, the upper portion of the cover unit 45A can be used as a finger hooking portion, which improves the operability of the cover unit 45A.

Next, the light-emitting unit 50 may be also configured as illustrated in FIG. 3B.

A cover unit 45B illustrated in FIG. 3B includes a light-emitting unit 50B. The light-emitting unit 50B is configured not to emit light over the entire periphery but to emit light over a half of the periphery. In this point, the light-emitting unit 50B is different from the above-described light-emitting unit 50A.

Note that, in the light-emitting unit 50B in FIG. 3B, a side located in the −Y direction and a side located in the +X direction emit light at an upper end portion of the cover unit 45B, but a side located in the +Y direction and a side located in the −X direction may emit light.

Alternatively, at the upper end portion of the cover unit 45B, other two of four sides of the side located in the −Y direction, the side located in the +Y direction, the side located in the −X direction, and the side located in the +Y direction may emit light. Alternatively, any one of the four sides may emit light, or any three of the four sides may emit light.

The light-emitting unit 50 may be also configured as illustrated in FIG. 3C.

A cover unit 45C illustrated in FIG. 3C includes a light-emitting unit 50C. In this embodiment, the cover unit 45C has a configuration in which an upper end portion is formed in a planar shape, and the entire surface of the upper end portion emits light.

However, in a configuration in which the inside of an outer peripheral portion of the upper end portion of the cover unit 45C is recessed and the outer peripheral portion protrudes upward in a manner similar to the other cover units 45 described above, the outer peripheral portion and the inside of the outer peripheral portion may be configured to emit light.

The light-emitting unit 50 may be also configured as illustrated in FIG. 3D.

A cover unit 45D illustrated in FIG. 3D includes a light-emitting unit 50D. In this embodiment, the cover unit 45D has a configuration in which the light-emitting unit 50D is provided inside a recessed part inside an outer peripheral portion at an upper portion of the cover unit 45D, and a part of the inside of the outer peripheral portion emits light. However, the upper portion of the cover unit 45D may be formed in a planar shape in a manner similar to the above-described cover unit 45C, and the light-emitting unit 50D may be provided at a part thereof.

Note that the light-emitting unit 50D has a rectangular shape in plan view. However, the shape is not limited thereto and may be the shape of another figure. Further, the shape is not limited to the shape of a figure and may be the shape of a character.

As described above, each of the light-emitting units 50A, 50B, 50C, and 50D is provided at the upper portion of the cover unit 45, which improves the visibility of the light- emitting unit 50.

The light-emitting unit 50 may be also configured as illustrated in FIG. 3E.

A cover unit 45E illustrated in FIG. 3E includes a light-emitting unit 50E. In this embodiment, the light-emitting unit 50E has a configuration in which a side in the +Y direction and a side in the −X direction emit light at a lower end portion of the cover unit 45E.

However, in the light-emitting unit 50E, other two or any one of three sides of the side located in the +Y direction, the side located in the −X direction, and a side located in the +X direction and located in the +Y direction relative to the operating panel 15 at the lower end portion of the cover unit 45E may emit light.

The light-emitting unit 50 may be also configured as illustrated in FIG. 3F.

A cover unit 45F illustrated in FIG. 3F includes a light-emitting unit 50F. In this embodiment, the light-emitting unit 50F is configured to be provided at a part of a side in the +Y direction at a lower end portion of the cover unit 45F.

However, the light-emitting unit 50F may be configured to be provided at a part of a side in the −X direction at the lower end portion of the cover unit 45F.

As described above, in the cover units 45E and 45F, the light-emitting units 50E and 50F each are provided at the lower end portion of the side surface located above the remaining amount visual recognition portions 23. Thus, it is possible to visually recognize the remaining amount visual recognition portions 23 and the light-emitting unit 50 at a short distance from each other, and facilitate the user to visually recognize information about the remaining ink amounts.

The light-emitting unit 50 may be configured as illustrated in FIG. 3G.

A cover unit 45G illustrated in FIG. 3G includes a light-emitting unit 50G. In this embodiment, the light-emitting unit 50G has a shape extending in the −Z direction. The light-emitting unit 50G is provided at an end portion in the −X direction at a side surface in the +Y direction of the cover unit 45G.

However, the light-emitting unit 50G may be provided at an end portion in the +X direction or the center in the X-axis direction at the side surface of the cover unit 45G in the +Y direction.

The light-emitting unit 50 may be also configured as illustrated in FIG. 3H.

A cover unit 45H illustrated in FIG. 3H includes a light-emitting unit 50H. In this embodiment, the light-emitting unit 50H is provided at a part of a side surface of the cover unit 45G in the +Y direction.

Note that the light-emitting unit 50H has a rectangular shape in plan view. However, the shape is not limited thereto and may be the shape of another figure. Further, the shape is not limited to the shape of a figure and may be the shape of a character.

As described above, in the cover units 45G and 45H, the light-emitting units 50G and 50H each are provided at the side surface located above the remaining amount visual recognition portions 23. Thus, the remaining amount visual recognition portions 23 and the light-emitting unit 50 can be visually recognized at the same surface, and the user can easily visually recognize information about the remaining ink amounts.

As described above, the light-emitting unit 50 according to each of the above-described embodiments is provided at the cover unit 45 that can be switched between a closed state in which the ink supplying ports 19 for supplying ink are covered and an open state in which the ink supplying ports 19 are exposed. In addition, as described in detail below, light sources 60 are also provided at the cover unit 45. In this way, the light-emitting unit 50 and the light sources 60 are provided at the cover unit 45. Thus, when maintenance work such as replacement of the light sources 60 is required, it is only required to remove the cover unit 45 or it is possible to perform the maintenance work without removing the cover unit 45. This eliminates the necessity of disassembling the device housing on a large scale and facilitates the maintenance work.

In this embodiment, the light-emitting unit 50 emits light in accordance with the remaining ink amounts accommodated in the ink accommodating unit 10, but no such limitation is intended. The light-emitting unit 50 may emit light in accordance with other states of the device main body 2, for example, various states at times of various errors, maintenance, printing, document reading, and the like. In addition, an operation may be guided using emitted light.

The following (1) to (12) are specific examples thereof. Only one of the following (1) to (12) may be employed, or any plurality thereof may be employed.
(1) The discharging tray 13 is provided with a sensor for detecting the presence or absence of a medium. When a medium on which recording has been performed is discharged to the discharging tray 13 and then the discharged medium is not taken out by the user even after a lapse of a predetermined time, the light-emitting unit 50 is caused to emit light as a notification of such a situation.

Note that the light-emitting unit 50 may be caused to emit light in order to notify completion of discharge of the medium to the discharging tray 13.
(2) A discharging tray (not illustrated) of the document feeding device 9 included in the printer 1B is provided with a sensor for detecting the presence or absence of a document. When a read document is discharged to the discharging tray and then the discharged document is not taken out by the user even after a lapse of a predetermined time, the light-emitting unit 50 is caused to emit light as a notification of such a situation.
(3) In a case where a document is placed at the document table 6, when the document remains placed even after a lapse of a predetermined time, the light-emitting unit 50 is caused to emit light as a notification of such a situation.
(4) When no medium is in a medium accommodating cassette (not illustrated) or no medium is at a medium feeding tray (not illustrated), the light-emitting unit 50 is caused to emit light as a notification of such a situation based on information from a sensor that detects the situation.
(5) A feeding tray (not illustrated) of the document feeding device 9 included in the printer 1B is provided with a sensor for detecting the presence or absence of a document. When a document subsequent to a preceding document is not present at the feeding tray, the light-emitting unit 50 is caused to emit light as a notification of such a situation.
(6) The discharging tray 13 is provided with a sensor for detecting that the number of media reaches a limit of a stackable number. When the number of media reaches the limit of the stackable number, the light-emitting unit 50 is caused to emit light as a notification of such a situation.
(7) The discharging tray (not illustrated) of the document feeding device 9 included in the printer 1B is provided with a sensor for detecting that the number of documents reaches a limit of a stackable number. When the number of documents reaches the limit of the stackable number, the light-emitting unit 50 is caused to emit light as a notification of such a situation.
(8) When wireless communication is possible between a control unit (not illustrated) included in each of the printers 1A and 1B and an external information terminal, the light-emitting unit 50 is caused to emit light as a notification that wireless communication is being performed.
(9) When each of the printers 1A and 1B is configured to be driven by a battery, the light-emitting unit 50 is caused to emit light as a notification that charging is being performed.
(10) The light-emitting unit 50 is caused to emit light as a notification that a time for replacement of a consumable item is approaching or has come. Examples of the consumable item include a feeding roller.
(11) A sensor for detecting an open or closed state of an opening and closing part is provided. When the opening and closing part remains open for a predetermined time, the light-emitting unit 50 is caused to emit light as a notification of such a situation. Examples of the opening and closing part include the document cover 8, the document feeding device 9, the cover unit 45, and the opening and closing lever 21.
(12) When a maintenance operation of the ink ejecting head 17 is being performed or initial filling of ink is being performed, the light-emitting unit 50 is caused to emit light as a notification of such a situation.

Note that, in this embodiment, the light-emitting unit 50 emits light in accordance with the remaining ink amounts accommodated in the ink accommodating unit 10. In other words, the cover unit 45 is configured to emit light in accordance with the remaining ink amounts accommodated in the ink accommodating unit 10, that is, a part to be operated first by the user at the time of the end of ink is configured to emit light. This allows the user to visually recognize the part to be operated next and can improve usability.

Further, the cover unit 45 is opened or closed by rotating with the upper end portion as a free end during the rotation. Further, the cover unit 45 in the closed state is opened by forward movement of the upper portion, and the cover unit 45 in the open state is closed by backward movement of the upper portion.

This requires no space above and besides the device when the cover unit 45 is opened and closed, which can save the space required for device installation.

In addition, since the region inside the outer peripheral portion is recessed at the upper end portion of each of the cover units 45A, 45B, 45D, 45E, 45F, 45G, and 45H, the user can open and close the cover unit 45 by hooking his/her finger at the upper end portion of the cover unit, which improves the operability of the cover unit 45. In addition, in the cover unit 45A, the light-emitting unit 50A is a part at which the user hooks his/her finger, which makes a part to be operated by the user more easily recognizable.

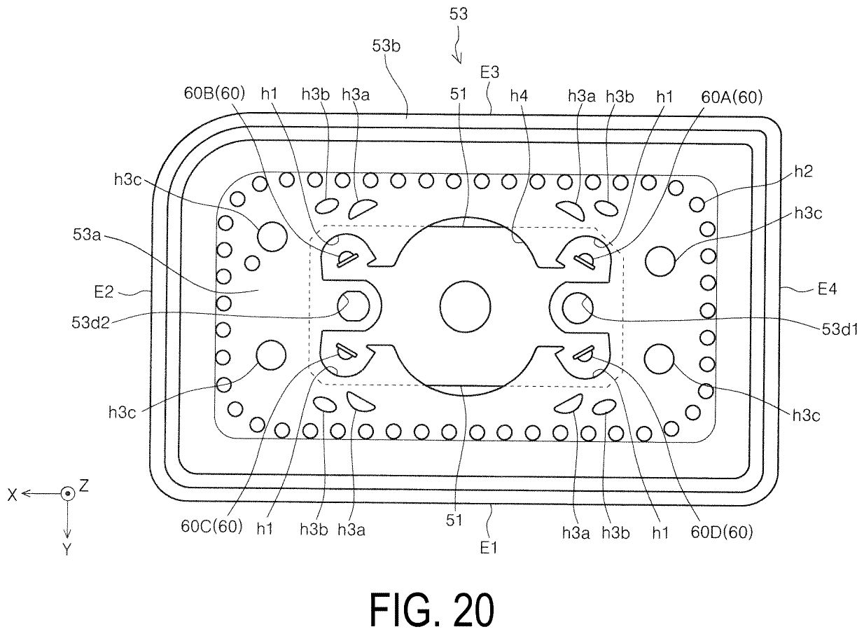

Note that the light-emitting part of the light-emitting unit 50A illustrated in FIG. 3A may be controlled so as to visually move along the outer periphery of the cover unit 45A. As described in detail below, in this embodiment, the light-emitting unit 50A includes four light sources 60 (see FIG. 20), and by sequentially turning on and off the four light sources 60 in a clockwise direction or a counterclockwise direction, it is possible to make the light-emitting part of the light-emitting unit 50A look as if it visually moves along the outer periphery of the cover unit 45A. This further improves the visibility of the light-emitting unit 50.

Note that, as described above, the expression “the light-emitting part of the light-emitting unit 50A visually moves” does not mean that the light-emitting unit 50A moves physically, but means that the light-emitting part of the light-emitting unit 50A changes with time and consequently the light-emitting part looks as if it moves.

Note that, for example, in the light-emitting unit 50F illustrated in FIG. 3F or the light-emitting unit 50G illustrated in FIG. 3G, the light-emitting part may visually look as if it moves linearly. That is, when the plurality of light sources are linearly arranged, and the light sources are sequentially turned on and off from one end toward the other end, it is possible to make the light-emitting part look as if it moves linearly.

### Positional Relationship between Ink Accommodating Unit and Scanner Unit

Next, a positional relationship between the ink accommodating unit 10 and the scanner unit 3 will be described. Note that, among the cover units of the plurality of embodiments described above, the cover unit 45A is used as an example of the cover unit 45 in the following description.

When the ink accommodating unit 10 is refilled with ink, it is preferable that a space above the ink accommodating unit 10 be largely open from the viewpoint of workability. When the scanner unit 3 covers the space above the ink accommodating unit 10, it is necessary to open the scanner unit 3. In order to open the scanner unit 3, a large space above the device is required.

In order to solve such a problem, it is conceivable to provide the ink accommodating unit 10 so as to largely protrude forward or sidewards of the device, but, in this case, the size of the device increases as a whole.

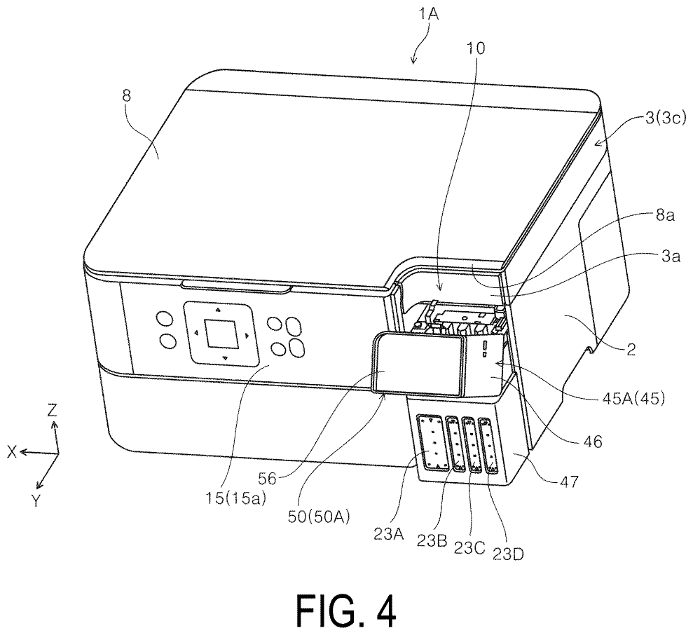

Thus, in the printer 1A according to this embodiment, the scanner unit 3 includes a notch portion 3a at a corner portion on the device front side as illustrated in FIG. 4. Then, the cover unit 45, which is a part of the ink accommodating unit 10, is inserted into the notch portion 3a, and also a space above the ink accommodating unit 10 is open.

With such a configuration, it is possible to access the ink accommodating unit 10 from above without opening the scanner unit 3, and to easily perform an operation of refilling the ink accommodating unit 10 with ink. In addition, since a part of the ink accommodating unit 10 is provided in a state of being inserted into the notch portion 3a, the ink accommodating unit 10 does not largely protrude forward from the device front surface, and it is possible to suppress an increase in the size of the device.

Note that, in this embodiment, the printer 1 includes the notch portion 3a and the ink accommodating unit 10 at the corner portion in the −X direction on the device front side, but may include the notch portion 3a and the ink accommodating unit 10 at a corner portion in the +X direction on the device front side.

In plan view of the device, the shape of the notch portion 3a is along the outer shape of the cover unit 45 (see FIG. 14). Accordingly, a wasteful space is not formed between the cover unit 45 and the scanner unit 3, which can suppress an increase in the size of the device.

Note that the notch portion along the outer shape of the cover unit 45 is formed not only at the unit main body 3c but also at the document cover 8 as indicated by the reference sign 8a. Accordingly, it is possible to access the ink accommodating unit 10 from above without opening the document cover 8, and to easily perform an operation of refilling the ink accommodating unit 10 with ink. Note that the notch portion 3a formed at the unit main body 3c and the notch portion 8a formed at the document cover 8 have substantially the same contour in plan view of the device, that is, as viewed from the +Z direction (see FIG. 14).

Note that, in the printer 1B provided with the document feeding device 9 as illustrated in FIG. 2, the scanner unit 3 similarly includes a notch portion 3a, and the cover unit 45, which is a part of the ink accommodating unit 10, is inserted into the notch portion 3a. A notch portion 9a is also formed at the document feeding device 9. Thus, a space above the ink accommodating unit 10 is open.

Note that the notch portion 3a formed at the unit main body 3c and the notch portion 9a formed at the document feeding device 9 have substantially the same contour in plan view of the device, that is, as viewed from the +Z direction. However, in the document feeding device 9, the notch portion 9a is formed so as to be slightly larger toward the +Z direction.

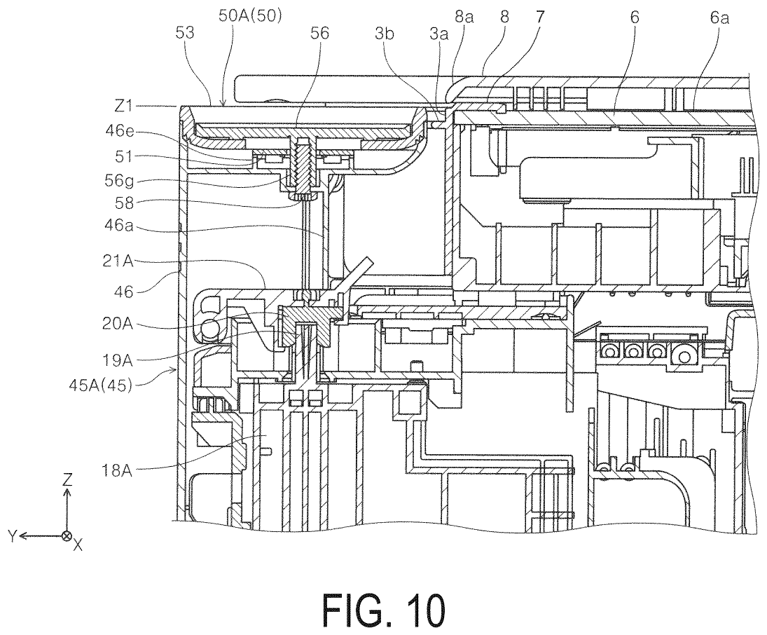

Next, as illustrated in FIG. 10, the height position of the upper end portion of the cover unit 45 in the closed state and the height position of a placement surface 6a of the document table 6 are aligned in the vertical direction. The upper end portion of the cover unit 45 is a part of the cover unit 45 located farthest in the +Z direction of the Z-axis direction. In FIG. 10, the reference sign Z1 indicates the height position of the upper end portion of the cover unit 45 and the height position of the placement surface 6a of the document table 6. Thus, the following operations and effects can be obtained.

In a case in which the size of a document is larger than the size of the document table 6, the document protrudes from the document table 6 when placed at the document table 6. In this case, when the height position of the upper end portion of the cover unit 45 in the closed state is much higher than the height position of the document table 6, the cover unit 45 becomes an obstacle. On the other hand, when the height position of the upper end portion of the cover unit 45 in the closed state is much lower than the height position of the document table 6, the document may hang down significantly and thus a trouble may arise such as the document being easily skewed with respect to the document table 6 or being curled.

However, as described above, since the height position of the upper end portion of the cover unit 45 in the closed state and the height position of the placement surface 6a of the document table 6 are aligned, it is possible to suppress the above-described trouble.

Note that the expression “the height position of the upper end portion of the cover unit 45 in the closed state and the height position of the placement surface 6a of the document table 6 are aligned” not only means that the height position of the upper end portion of the cover unit 45 in the closed state and the height position of the placement surface 6a of the document table 6 are the same, but also means that there is a slight error to an extent of not causing the above trouble. As an example, the difference between the height position of the upper end portion of the cover unit 45 in the closed state and the height position of the placement surface 6a of the document table 6 is preferably less than 8 mm, more preferably less than 4 mm, and still more preferably 0 to 2 mm.

When the operating panel 15 is in the first state, that is, when the panel surface 15a is along the vertical plane, the operating panel 15 is within a region Wb of the cover unit 45 in the Y-axis direction, that is, in the device depth direction (see FIG. 14). As illustrated in FIG. 11, the height position of the upper end portion of the cover unit 45 in the closed state and the height position of the upper end portion of the operating panel 15 in the first state are aligned. The upper end portion of the operating panel 15 is a part of the operating panel 15 located farthest in the +Z direction of the Z-axis direction. In FIG. 11, the reference sign Z1 indicates the height position of the upper end portion of the cover unit 45 and the height position of the upper end portion of the operating panel 15.

As a result, the height position of the upper end portion of the cover unit 45 in the closed state, the height position of the upper end portion of the operating panel 15 in the first state, and the height position of the placement surface 6a of the document table 6 are aligned.

Accordingly, the operating panel 15 does not become an obstacle when a document protrudes from the document table 6, and the document protruding from the document table 6 can be appropriately supported by the cover unit 45 and the operating panel 15.

Note that the expression “the height position of the upper end portion of the cover unit 45 in the closed state and the height position of the upper end portion of the operating panel 15 in the first state are aligned” not only means that the height position of the upper end portion of the cover unit 45 in the closed state and the height position of the upper end portion of the operating panel 15 in the first state are the same, but also means that there is a slight error to an extent of not causing the above-described trouble. As an example, the difference between the height position of the upper end portion of the cover unit 45 in the closed state and the height position of the upper end portion of the operating panel 15 in the first state is preferably less than 8 mm, more preferably less than 4 mm, and still more preferably 0 to 2 mm.

Note that even when the operating panel 15 is in the second state in which the panel surface 15a is tilted downward, the height position of the upper end portion of the cover unit 45 in the closed state and the height position of the upper end portion of the operating panel 15 are aligned (see FIGS. 12 and 13). As a result, the above-described operations and effects can be obtained regardless of the state of the operating panel 15. Note that, in FIG. 13, the reference sign Z1 indicates the height position of the upper end portion of the cover unit 45, the height position of the placement surface 6a of the document table 6, and the height position of the upper end portion of the operating panel 15 in the second state.

Next, as illustrated in FIG. 9, the scanner unit 3 includes a frame member 7 that forms the periphery of the document table 6. As illustrated in FIGS. 6 and 10, the frame member 7 is provided with a first step portion 3b for forming a clearance from the cover unit 45 in the planar direction, that is, the X-Y planar direction. This allows the user to easily recognize the presence of the cover unit 45 and improves usability.

Further, by forming the above clearance, when a large document that protrudes from the frame member 7 is placed and read, it is possible to suppress damage caused by the document being pinched between the document cover 8 and the cover unit 45.

When the operating panel 15 is in the first state as described above, that is, when the panel surface 15a is along the vertical plane, the operating panel 15 is within the region Wb of the cover unit 45 in the Y-axis direction, that is, the device depth direction (see FIG. 14). As illustrated in FIGS. 5 and 11, the operating panel 15 is provided with a second step portion 15b for forming a clearance from the cover unit 45 in the planar direction, that is, the X-Y planar direction. This allows the user to easily recognize the presence of the cover unit 45 and improves usability.

Next, other features of the ink accommodating unit 10 will be described below.

In this embodiment, the color of the outer surface of the ink accommodating unit 10 is different from the color of the outer surface of a part of the device main body 2 other than the ink accommodating unit 10. As an example, the lightness of the color of the outer surface of the ink accommodating unit 10 is higher than the lightness of the color of the outer surface of the part of the device main body 2 other than the ink accommodating unit 10. More specifically, the color of the outer surface of the part of the device main body 2 other than the ink accommodating unit 10 is black, and the color of the outer surface of the cover member 46 constituting the cover unit 45 and the color of the outer surface of the exterior member 47 are gray. Such a configuration allows the user to more easily recognize the presence of the cover unit 45 and improves usability.

Note that the lightness of the color of the outer surface of the ink accommodating unit 10 may be lower than the lightness of the color of the outer surface of the part of the device main body 2 other than the ink accommodating unit 10.

In addition, as described with reference to FIG. 3A, the cover unit 45A according to this embodiment has a configuration in which the upper end portion emits light, which allows the user to more easily recognize the presence of the cover unit 45A and improves usability.

Next, as illustrated in FIGS. 5 to 7, 8A, 8B, and 8C, a wall portion 46a is formed inside the cover member 46 constituting the cover unit 45. The wall portion 46a forms a surface along the X-Z plane when the cover unit 45 is in the closed state. Operations and effects of this wall portion 46a will be described below.

First, FIG. 8A illustrates a state in which the cover unit 45 is fully open and the opening and closing lever 21 is open. Closing the cover unit 45 in this state brings the wall portion 46a into contact with the opening and closing lever 21 and rotates the opening and closing lever 21 in a direction of closing the opening and closing lever 21, as illustrated in FIG. 8B. When the cover unit 45 is closed as illustrated in FIG. 8C, the wall portion 46a completely closes the opening and closing lever 21. In this way, the opening and closing lever 21 is also closed by closing the cover unit 45. Thus, even when the user forgets to perform an operation of closing the opening and closing lever 21, the opening and closing lever 21 can be closed, and moisture evaporation in the ink tank 18 can be suppressed.

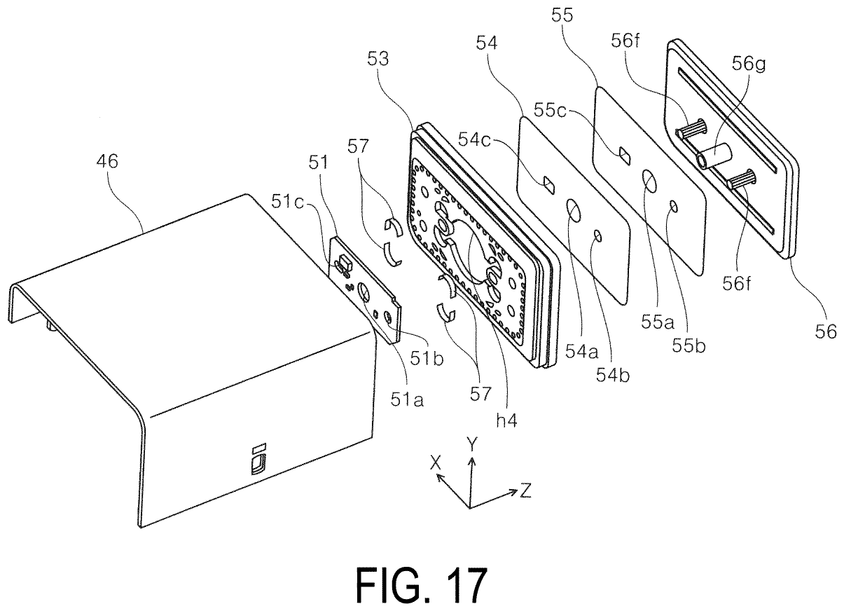

As illustrated in FIGS. 6, 7 and 11, a plate portion 46d is provided inside the cover member 46. The plate portion 46d forms a surface parallel to the X-Y plane in a state where the cover unit 45 is closed. A substrate 51 (see FIG. 17) described below is provided above the plate portion 46d in a state where the cover unit 45 is closed.

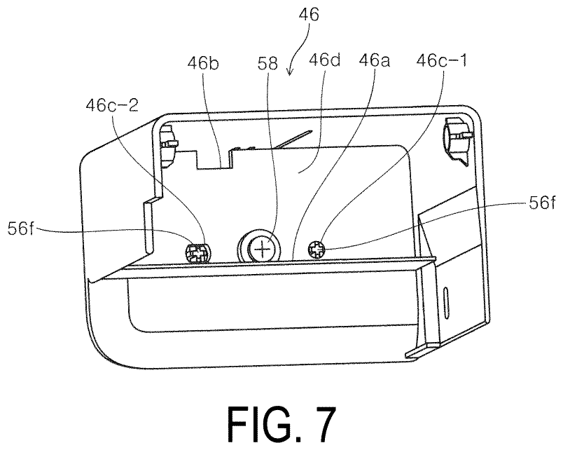

As illustrated in FIG. 7, a notch portion 46b and holes 46c-1 and 46c-2 are formed in the plate portion 46d. The notch portion 46b is a part through which a cable (not illustrated) extending from the substrate 51 (see FIG. 17) passes. The holes 46c-1 and 46c-2 are parts into which two bosses 56f formed at a holder 56 (see FIG. 17) described below are fitted.

When the cover unit 45 is opened, the user may carelessly touch the cable (not illustrated) extending from the notch portion 46b or the bosses 56f. This may cause static electricity to flow through the substrate 51 and may adversely affect the substrate 51.

However, since the wall portion 46a is provided inside the cover member 46, the cable (not illustrated) extending from the notch portion 46b and the bosses 56f are hidden by the wall portion 46a when the cover unit 45 is opened as illustrated in FIG. 5. This can suppress the user carelessly touching the cable (not illustrated) extending from the notch portion 46b and the bosses 56f.

### Positional Relationship Between Light-Emitting Unit and Components of Printer

Next, with the light-emitting unit 50A constituting the cover unit 45A as an example, the positional relationship between the light-emitting unit 50A and the components of the printer 1 will be described.

As illustrated in FIG. 14, when the operating panel 15 is in the first state, the operating panel 15 is within the region Wb of the light-emitting unit 50A in the Y-axis direction, that is, the device depth direction.

As illustrated in FIGS. 11 and 14, the ink supplying ports 19 are within a region Wa of the light-emitting unit 50A in the X-axis direction, that is, the device width direction.

As is clear from FIG. 1, the length of the document cover 8 in the X-axis direction, that is, the device width direction, is larger than the length of the light-emitting unit 50A.

Further, as is clear from FIG. 1, the remaining amount visual recognition portions 23 are within the region of the light-emitting unit 50A in the X-axis direction, that is, the device width direction. Accordingly, it is possible to visually recognize the remaining amount visual recognition portions 23 and the light-emitting unit 50A at a short distance from each other, and it is easy for the user to visually recognize information about the remaining ink amounts.

As illustrated in FIG. 14, when the reading sensor 5 constituting the scanner unit 3 is located at a home position in the X-axis direction, that is, the device width direction, the reading sensor 5 is within the region Wa of the light-emitting unit 50A.

In addition, the carriage 16 located at a home position is within the region Wa of the light-emitting unit 50A in the X-axis direction, that is, the device width direction.

As illustrated in FIG. 16, an upper surface of the carriage 16 is located below the light-emitting unit 50A in the vertical direction. Note that, in FIG. 16, the reference sign Z1 indicates a range occupied by the light-emitting unit 50A in the Z-axis direction, and the reference sign Z2 indicates the position of the upper surface of the carriage 16 in the Z-axis direction.

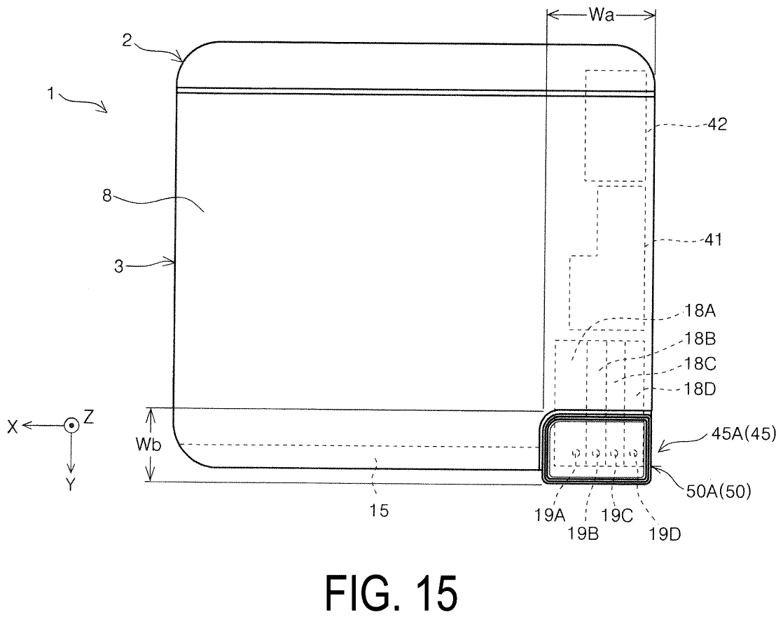

As illustrated in FIG. 15, the device main body 2 includes a maintenance unit 41 for performing maintenance of the ink ejecting head 17, and a waste liquid storage unit 42 that stores, as a waste liquid, ink ejected from the ink ejecting head 17 to the maintenance unit 41. Note that the maintenance unit 41 includes a cap portion (not illustrated) for capping the ink ejecting head 17 and a pump (not illustrated) for generating a negative pressure in the cap portion. The ink ejected to the cap portion is sent to the waste liquid storage unit 42 by the pump.

The carriage 16 located at the home position, the maintenance unit 41, and the waste liquid storage unit 42 are within the region Wa of the light-emitting unit 50A in the X-axis direction, that is, the device width direction.

### Detailed Configuration of Light-Emitting Unit

Next, with the light-emitting unit 50A constituting the cover unit 45A as an example, a detailed configuration of the light-emitting unit 50A will be described. Note that the cover unit 45A can also be referred to as a light-emitting device that emits light.

As illustrated in FIG. 17, the cover unit 45A includes the cover member 46, the substrate 51, color filters 57, a light-guiding member 53, a reflection sheet 54, a light-shielding sheet 55, and a holder 56.

As illustrated in FIG. 11, the cover member 46 is provided with the plate portion 46d described with reference to FIG. 7, and the substrate 51 is provided above the plate portion 46d. The light-guiding member 53 is provided at the top of the substrate 51. Although not illustrated in FIG. 11, the reflection sheet 54 illustrated in FIG. 17 is provided at the top of the light-guiding member 53, the light-shielding sheet 55 is provided at the top of the reflection sheet 54, and the holder 56 is provided at the top of the light-shielding sheet 55.

The light-emitting unit 50A is configured of a part of the light-guiding member 53.

A cylindrical screw fitting portion 56g is formed at a central portion of the holder 56. In FIG. 17, the screw fitting portion 56g passes through a hole 51a formed in a central portion of the substrate 51, a fourth hole h4 formed in the light-guiding member 53, a hole 54a formed in a central portion of the reflection sheet 54, and a hole 55a formed in a central portion of the light-shielding sheet 55.

A pedestal portion 46e (see FIGS. 6 and 11) serving as a pedestal of the substrate 51 is formed at the plate portion 46d of the cover member 46 along the outer shape of the substrate 51, and a recessed portion 46f is formed inside the pedestal portion 46e as illustrated in FIGS. 6 and 11. The screw fitting portion 56g of the holder 56 is fitted to the recessed portion 46f. As illustrated in FIG. 7, a screw 58 is fitted to the screw fitting portion 56g. Thus, the substrate 51, the light-guiding member 53, the reflection sheet 54, and the light-shielding sheet 55 are provided in a state of being sandwiched between the plate portion 46d and the holder 56.

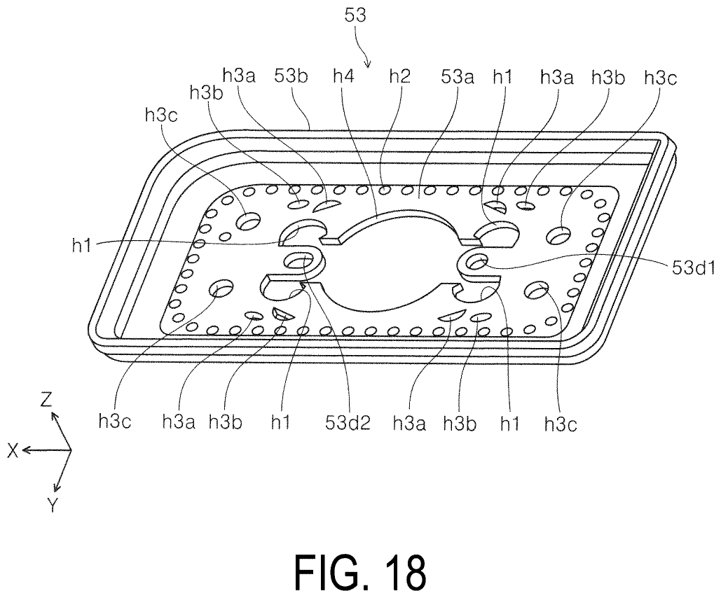

Note that the two bosses 56f are formed at the holder 56 so as to sandwich the screw fitting portion 56g. In FIG. 17, one boss 56f passes through a hole 55b formed in the light-shielding sheet 55, a hole 54b formed in the reflection sheet 54, a hole 53d1 formed in the light-guiding member 53 (see FIGS. 18 to 20), and a hole 51b formed in the substrate 51, and is fitted to the hole 46c-1 (see FIG. 7) formed in the plate portion 46d of the cover member 46.

The other boss 56f passes through a hole 55c formed in the light-shielding sheet 55, a hole 54c formed in the reflection sheet 54, a hole 53d2 formed in the light-guiding member 53 (see FIGS. 18 to 20), and a hole 51c formed in the substrate 51, and is fitted to the hole 46c-2 (see FIG. 7) formed in the plate portion 46d of the cover member 46.

The relative positions of the cover member 46, the holder 56, the light-shielding sheet 55, the reflection sheet 54, the light-guiding member 53, and the substrate 51 in the X-Y plane are determined by the bosses 56f.

Note that, unlike the hole 55b, the hole 55c formed in the light-shielding sheet 55 is formed as an elongated hole extending in the X-axis direction. Similarly, unlike the hole 54b, the hole 54c formed in the reflection sheet 54 is formed as an elongated hole extending in the X-axis direction. Similarly, unlike the hole 51b, the hole 51c formed in the substrate 51 is formed as an elongated hole extending in the X-axis direction. Similarly, unlike the hole 53d1, the hole 53d2 formed in the light-guiding member 53 is formed as an elongated hole extending in the X-axis direction. Similarly, unlike the hole 46c-1 (see FIG. 7), the hole 46c-2 (see FIG. 7) formed in the cover member 46 is formed as an elongated hole extending in the X-axis direction.

Due to the above configuration, even when there are some errors in the positions of the holes formed in each member, the two bosses 56f can be fitted to the two holes formed in each member.

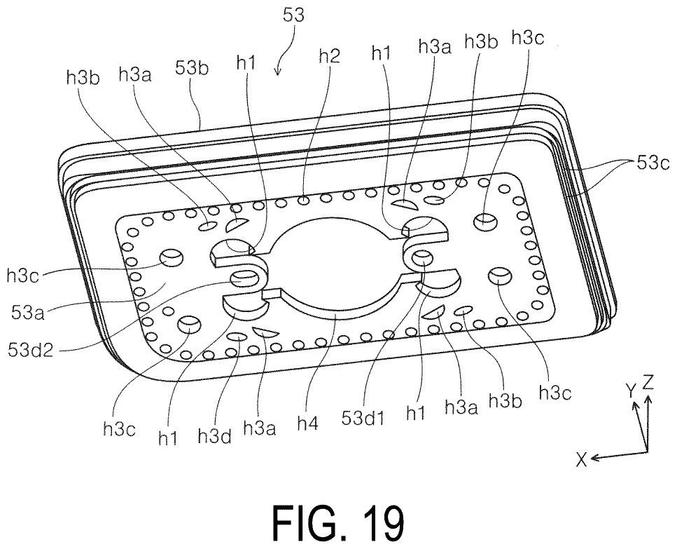

Next, as illustrated in FIGS. 18 and 19, the light-guiding member 53 integrally includes a planar plate portion 53a and an outer wall portion 53b standing in a direction intersecting a surface of the plate portion 53a, specifically, in the +Z direction. The outer wall portion 53b is provided along the periphery of the plate portion 53a.

A large number of holes are provided in the plate portion 53a, and the light sources 60 provided at the substrate 51 are disposed inside the first holes h1, which are some of the large number of holes, as illustrated in FIG. 20.

In FIG. 20, the reference signs E1, E2, E3, and E4 indicate peripheral edges of the light-guiding member 53 in plan view of the plate portion 53a, the peripheral edges E1 and E3 are peripheral edges extending along the X-axis direction, and the peripheral edges E2 and E4 are peripheral edges extending along the Y-axis direction. A part where two of the peripheral edges intersect is formed in a round shape. The length of each of the peripheral edges E1 and E3 is larger than the length of each of the peripheral edges E2 and E4.

Note that when it is not necessary to distinguish the peripheral edges E1, E2, E3, and E4, they are hereinafter collectively referred to as peripheral edges E. Note that when the peripheral edges E1, E2, E3, and E4 are collectively referred to as the peripheral edges E, the peripheral edges E include not only the peripheral edges E1, E2, E3, and E4, but also the parts where the peripheral edges intersect each other, that is, the parts formed in a round shape.

In this embodiment, the four light sources 60 are disposed. The light sources 60 are disposed so as to emit light in mutually opposite outward directions. Specifically, a light source 60A emits light such that the center of the light emission direction includes a −X direction component and a −Y direction component. A light source 60B emits light such that the center of the light emission direction includes a +X direction component and a −Y direction component. A light source 60C emits light such that the center of the light emission direction includes a +X direction component and a +Y direction component. A light source 60D emits light such that the center of the light emission direction includes a −X direction component and a +Y direction component.

Note that when it is not necessary to distinguish the light sources 60A, 60B, 60C, and 60D, they are collectively referred to as light sources 60.

Light emitted from the light sources 60 is incident on the light-guiding member 53 from inner side surfaces, that is, inner surfaces, of the first holes h1, travels toward the peripheral edges E of the light-guiding member 53, and exits from the outer wall portion 53b. That is, the outer wall portion 53b constitutes the light-emitting unit 50A. Note that the inner side surface of each first hole h1 may be hereinafter simply referred to as a side surface of the first hole h1 or an inner surface of the first hole h1.

Since light emitted from the light sources 60 travels inside the light-guiding member 53, the light-guiding member 53 is formed of a material having optical transparency, for example, an optically transparent resin material. As the optically transparent resin material, for example, a resin material such as an acrylic resin material, a styrene resin material, a polyethylene resin material, or polycarbonate can be used. Of course, instead of the optically transparent resin material, glass may be used for the light-guiding member 53.

The light-guiding member 53 preferably contains a light-diffusing material. Thus, it is possible to blur light reflected inside the light-guiding member 53, and make the light look as if it is emitted uniformly.

The light-diffusing material is only required to be a substance added to the optically transparent material to have a light-diffusing function. For example, inorganic particles of aluminum oxide, silicon oxide, titanium oxide, calcium carbonate, or the like, or organic particles of silicone resin, acrylic resin, or the like, can be used.

Instead of containing the light-diffusing material, a light-diffusing resin may be used. As an example, a light-diffusing resin of DELPET (trade name of Asahi Kasei Corporation) manufactured by this company can be used.

Note that, instead of or in addition to containing the light-diffusing material in the light-guiding member 53, the surface of the light-guiding member 53 may be subjected to emboss processing. Thus, it is possible to blur light reflected inside the light-guiding member 53, and make the light look as if it is emitted uniformly.

Further, light-diffusing surfaces may be disposed at the inner surfaces of the first holes h1. This makes the bright spots less conspicuous and the light can be easily visually recognized as uniformly emitted light. The light-diffusing surfaces in this case can be achieved by embossing the inner surfaces of the first holes h1 or by disposing films having light-diffusing properties between the light sources 60 and the inner surfaces of the first holes h1. The color filters 57 described below may have such light-diffusing properties.

In order to achieve light emission uniformity, the scattering angle is preferably 15 to 30 degrees, more preferably 20 degrees.

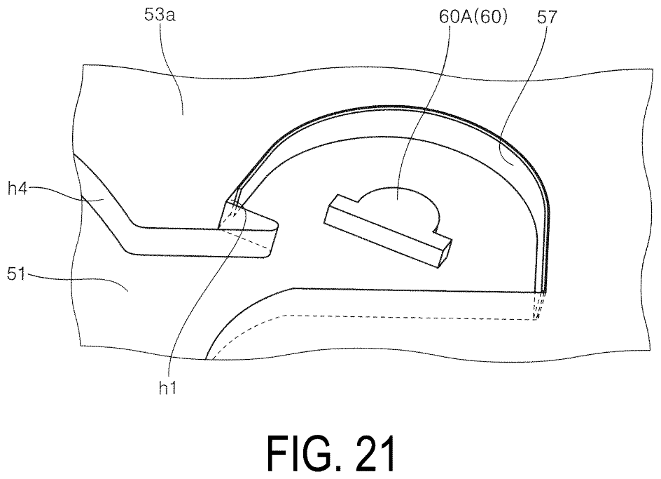

As the light sources 60, for example, a light-emitting diode (LED) can be adopted. Although there are various colors of LEDs, a white LED is used in this embodiment. As illustrated in FIG. 21, the color filter 57 is disposed between the inner surface of the first hole h1 and the light source 60, and the color of emitted light is adjusted by the color filter 57. The color of the emitted light can be easily adjusted by the color filter 57. As an example, a blue color filter can be adopted as the color filter 57. The color filter 57 is preferably provided so as to cover the entire inner side of the first hole h1.

Note that, in this embodiment, since the color filter 57 is flexible and is disposed in a state of being curved in an arc shape, the color filter 57 can cling to the inner surface of the first hole h1 by a force of returning to the original linear state. However, the color filter 57 may be entirely or partially fixed by using a double-sided tape, an adhesive, or the like.

Next, second holes h2 and third holes h3 formed in the plate portion 53a will be described. The second holes h2 and the third holes h3 are holes for making the light-emitting unit 50A, that is, the light-emitting unit 50A that emits light in a ring shape, look as if it uniformly emits light with uneven brightness suppressed. In particular, of parts close to the light sources 60 and parts far from the light sources 60, the brightness of the close parts is likely to be relatively higher than that of the far parts, but this is suppressed by holes described below.

Note that each hole described below is a hole penetrating the plate portion 53a in the thickness direction, that is, the Z-axis direction, but may be a recessed portion not penetrating a surface of the plate portion 53a in the +Z direction or a surface in the −Z direction.

As illustrated in FIGS. 18 to 20, the four first holes h1 are formed in the plate portion 53a in this embodiment. As described above, the light sources 60 are disposed in the first holes h1.

In plan view of the plate portion 53a, the plurality of second holes h2 are provided at intervals along the peripheral edges E between the first holes hl and the peripheral edges E. In addition, in plan view of the plate portion 53a, third holes h3a, h3b, and h3c are formed between the first holes h1 and the second holes h2. Note that when the third holes h3a, h3b, and h3c are not distinguished, they are collectively referred to as third holes h3.

A fourth hole h4 is formed in a central portion of the plate portion 53a. In this embodiment, the first holes h1 communicate with the fourth hole h4 for heat dissipation of the light sources 60. However, when it is not necessary to dissipate heat from the light sources 60, the first holes hl do not need to communicate with the fourth hole h4.

Operations and effects of each hole will be described below.

First, operations and effects of the second holes h2 will be described.

Since the light sources 60 emit light toward the side surfaces of the first holes h1, the light emitted from the light sources 60 is incident from the side surfaces of the first holes h1 and travels toward the peripheral edges E of the light-guiding member 53 in plan view of the plate portion 53a. The light traveling toward the peripheral edges E of the light-guiding member 53 exits from the outer surface of the light-guiding member 53. Thus, it is possible to visually recognize as if the outer surface of the light-guiding member 53 emits light. Note that the peripheral edges E of the light-guiding member 53 may serve as the outer surface that emits light, or a part other than the peripheral edges E may serve as the outer surface that emits light as a result of light being reflected by the peripheral edges E. In this specification, the peripheral edges E are edges forming the outer shape of the light-guiding member 53 when the plate portion 53a is seen in plan view.

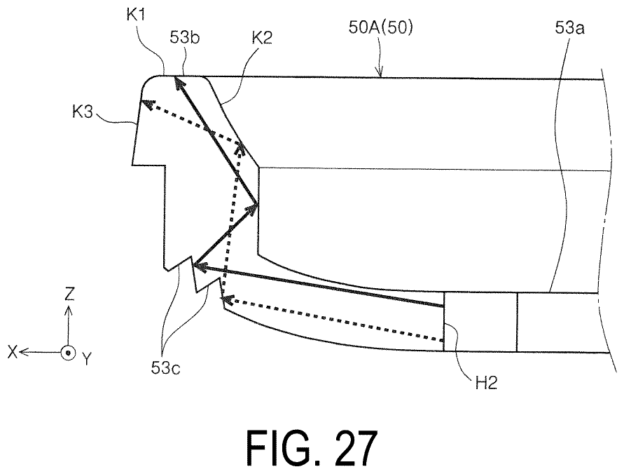

The light-emitting surfaces in this embodiment are a top light-emitting surface K1, an inner light-emitting surface K2, and an outer light-emitting surface K3 illustrated in FIG. 27. This will be described again below. The top light-emitting surface K1, the inner light-emitting surface K2, and the outer light-emitting surface K3 are surfaces that form the outer wall portion 53b. In this embodiment, the outer light-emitting surface K3 corresponds to the peripheral edges E.

Note that the term “outer surface” described below means the outer surface of the light-guiding member 53. The top light-emitting surface K1, the inner light-emitting surface K2, and the outer light-emitting surface K3 are examples of the outer surface of the light-guiding member 53.

Here, in order for light to exit from the outer surface of the light-guiding member 53, the light needs to travel at an angle at which the light is not totally reflected with respect to the outer surface of the light-guiding member 53. Thus, when the amount of light totally reflected at a predetermined position of the outer surface of the light guiding member 53 is larger than the amount of light not totally reflected, the brightness at the predetermined position decreases. On the other hand, when the amount of light not totally reflected at a predetermined position of the outer surface of the light guiding member 53 is larger than the amount of light totally reflected, the brightness at the predetermined position increases. For this reason, the brightness may be uneven as a whole at the outer surface of the light-guiding member 53.

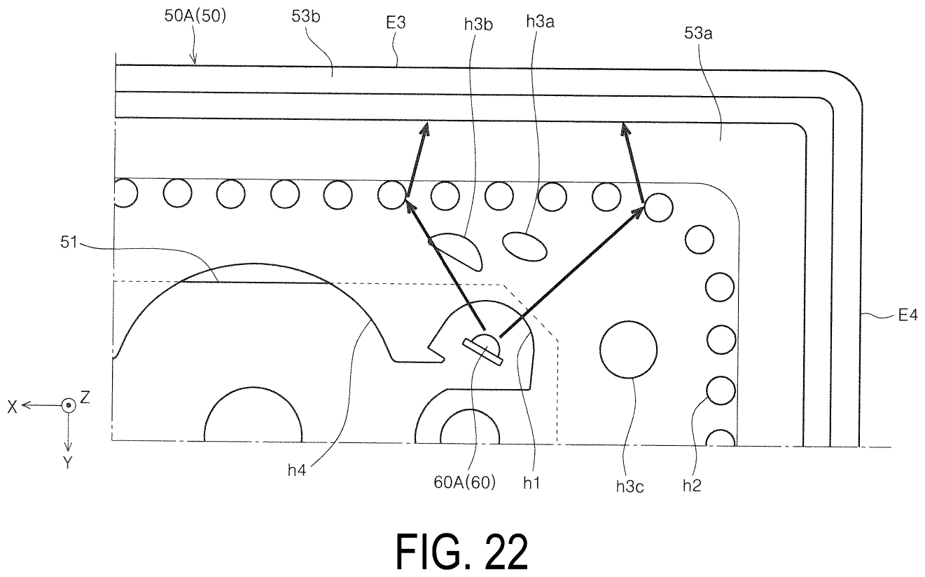

However, according to this embodiment, since light incident from the side surfaces of the first holes h1 is reflected by the side surfaces of the plurality of second holes h2, the light incident from the first holes hl travels in more directions. Arrows in FIG. 22 indicate an example of light reflected by the side surfaces of the second holes h2.

Thus, the ratio between the amount of light totally reflected by the outer surface of the light-guiding member 53 and the amount of light not totally reflected is made uniform at the outer surface of the light-guiding member 53. As a result, it is possible to suppress uneven brightness when the light-guiding member 53 emits light and obtain a favorable light emission state.

Next, operations and effects of the third holes h3 will be described.

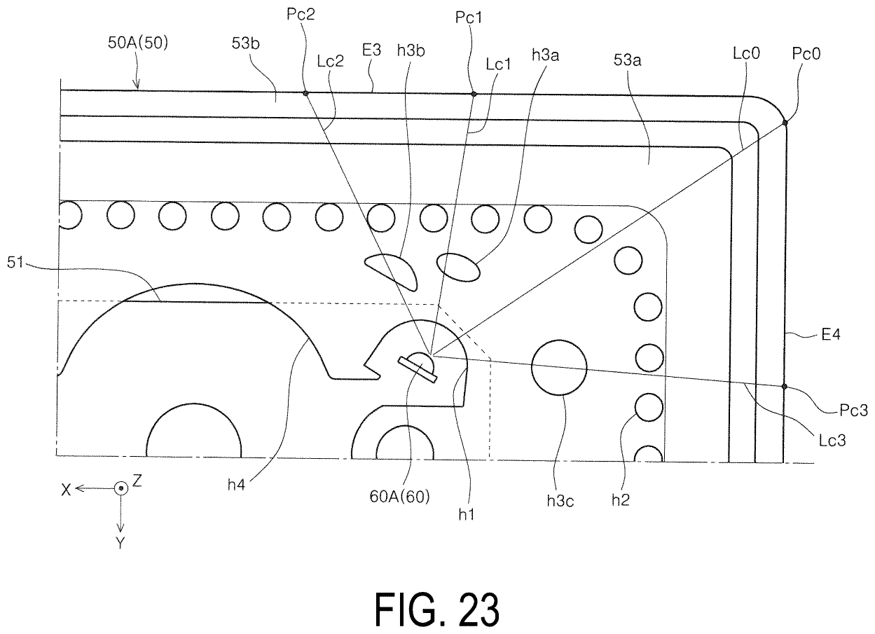

In FIG. 23, in plan view of the plate portion 53a, a line connecting the light source 60 and a first part Pc0 of the peripheral edge E is defined as a first straight line Lc0, a line that connects the light source 60 and a second part Pc1 of the peripheral edge E and that is a straight line shorter than the first straight line Lc0 is defined as a second straight line Lc1. The third hole h3a is provided at a position intersecting the second straight line Lc1.

In addition, a line that connects the light source 60 and a second part Pc2 of the peripheral edge E and that is a straight line shorter than the first straight line Lc0 is defined as a second straight line Lc2. The third hole h3b is provided at a position intersecting the second straight line Lc2.

In addition, a line that connects the light source 60 and a second part Pc3 of the peripheral edge E and that is a straight line shorter than the first straight line Lc0 is defined as a second straight line Lc3. The third hole h3c is provided at a position intersecting the second straight line Lc3.

Note that the first straight line Lc0 has the shortest distance between the light source 60 and the first part Pc0. The second straight line Lc1 also has the shortest distance between the light source 60 and the second part Pc1. The second straight line Lc2 also has the shortest distance between the light source 60 and the second part Pc2. The second straight line Lc3 also has the shortest distance between the light source 60 and the second part Pc3. Thus, each straight line may be rephrased as a line segment.

Note that, in FIG. 23, the first part Pc0 and the second parts Pc1, Pc2, and Pc3 are parts used for the sake of description of the arrangement of the third holes h3, and the respective parts are not limited to the positions illustrated in FIG. 23.

In the light-guiding member 53, the brightness of the outer surface closer to the light sources 60 is likely to be higher than that of the outer surface farther from the light sources 60, which causes uneven brightness.

However, in this embodiment, the third holes h3 are provided at positions intersecting the second straight lines Lc1, Lc2, and Lc3, which are shorter than the first straight line Lc0. Thus, since light is reflected at the side surfaces of the third holes h3, it is possible to suppress an increase in the brightness of the outer surface close to the light sources 60 and suppress uneven brightness.

For example, the third hole h3a can suppress the brightness of the second part Pc1 becoming higher than the brightness of the first part Pc0. In addition, the third hole h3b can suppress the brightness of the second part Pc2 becoming higher than the brightness of the first part Pc0. In addition, the third hole h3c can suppress the brightness of the second part Pc3 becoming higher than the brightness of the first part Pc0.

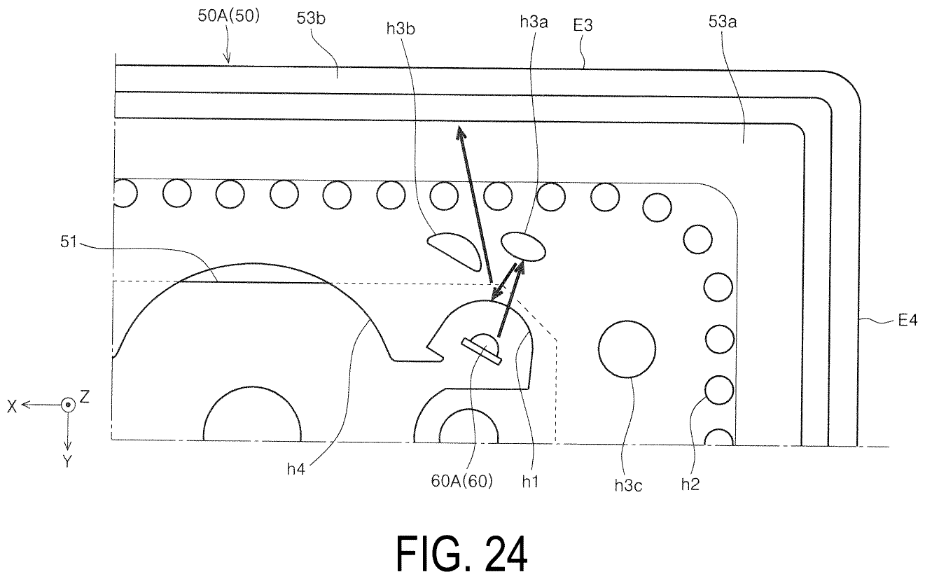

In addition, as indicated by arrows in FIG. 24, it can be expected that light reflected by the side surface of the third hole h3 returns to the first hole h1, is reflected by the side surface of the first hole h1, and travels toward the far outer surface.

The above are common operations and effects of the third holes h3a, h3b, and h3c, and hereinafter, the third holes h3a, h3b, and h3c will be individually described.

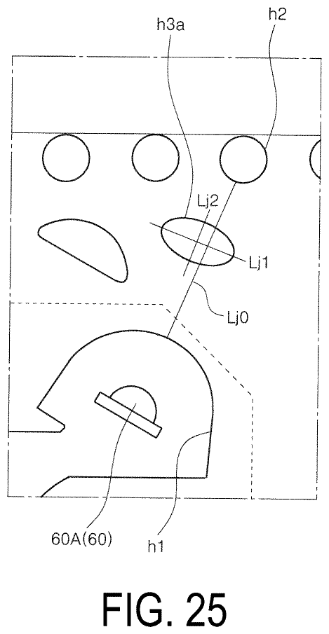

As illustrated in FIG. 25, the third hole h3a has an elliptical shape so as to increase the clearance from the first hole h1 and the clearance from the second hole h2.

More specifically, the third hole h3a has an elliptical shape having a major axis Lj1 and a minor axis Lj2, and the minor axis Lj2 is disposed along a straight line Lj0 connecting the first hole h1 and the second hole h2.

Note that the expression “the minor axis Lj2 is disposed along a straight line Lj0” does not necessarily mean that the minor axis Lj2 is precisely parallel to the straight line Lj0. The elliptical shape is only required to be disposed such that the clearance between the first hole h1 and the third hole h3a and the clearance between the second hole h2 and the third hole h3a can be left as compared with a perfect circular shape having the same diameter as the major axis Lj1.

Note that the second hole h2 adopted in FIG. 25 is an example, and another second hole h2 may be adopted. For example, as the second hole h2 adopted in FIG. 25, a second hole h2 closest to the first hole h1 may be adopted, or another second hole h2 may be adopted.

Note that the straight line Lj0 has the shortest distance between the first hole h1 and the second hole h2. Thus, the straight line Lj0 may be rephrased as a line segment Lj0.

The third hole h3a is to suppress the brightness of the outer surface close to the light source 60 and thus is preferably as large as possible. However, in a case in which the clearance between the first hole hl and the third hole h3a or the clearance between the second hole h2 and the third hole h3a is narrow, the fluidity of resin in a mold decreases when the light-guiding member 53 is resin-molded, which is likely to cause a molding defect.

However, according to this embodiment, since the third hole h3a has an elliptical shape so as to increase the clearance from the first hole h1 and the clearance from the second hole h2, it is possible to suppress narrowing of the clearance between the first hole hl and the third hole h3a and the clearance between the second hole h2 and the third hole h3a while widely reflecting light from the light source 60 toward the outer surface close to the light source 60, and suppress the above-described molding defect.

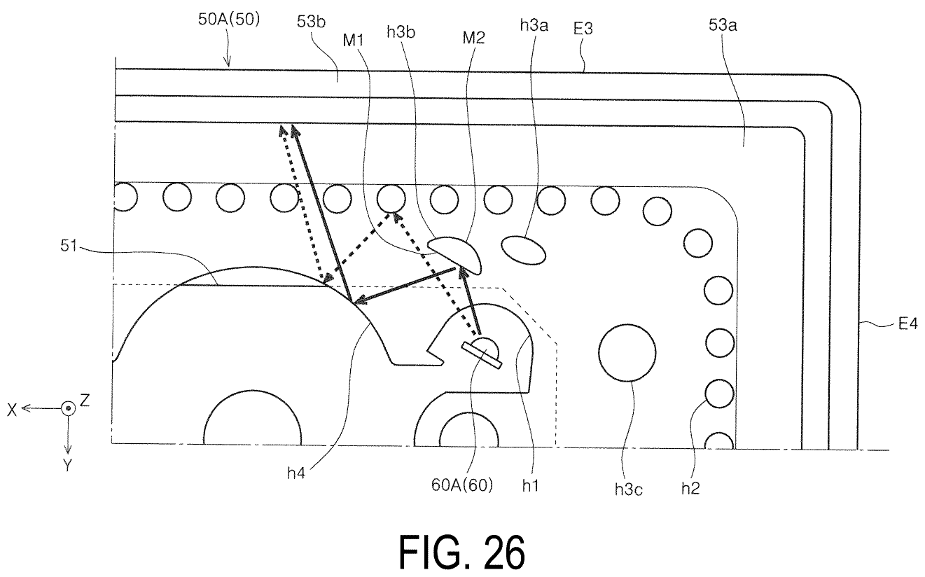

Next, the third hole h3b will be described with reference to FIG. 26.

The third hole h3b has a shape obtained by cutting a part of a circle so as to have a chord M1 and an arc M2, and the chord M1 is disposed so as to face the first hole h1.

The third hole h3b is to suppress the brightness of the outer surface close to the light source 60 and thus is preferably as large as possible. However, when the clearance between the first hole h1 and the third hole h3b or the clearance between the second hole h2 and the third hole h3b is narrow, the fluidity of resin in a mold decreases when the light-guiding member 53 is resin-molded, which is likely to cause a molding defect.

However, since the third hole h3b has a shape obtained by cutting a part of a circle so as to have the chord M1 and the arc M2, and the chord M1 is disposed so as to face the first hole h1, it is possible to suppress narrowing of the clearance between the first hole h1 and the third hole h3b and the clearance between the second hole h2 and the third hole h3b while widely reflecting light from the light source 60 toward the outer surface close to the light source 60, and suppress the above-described molding defect.

Note that when the third hole h3b is formed by cutting a part of a circle so as to have the chord M1 and the arc M2, a part of a perfect circle may be cut or a part of an ellipse may be cut.

Next, the third hole h3c will be described.

The third hole h3c has a perfect circular shape having a larger diameter than the second holes h2. Thus, the following operations and effects can be obtained.

Since the third hole h3c is to suppress the brightness of the outer surface close to the light source 60, the third hole h3c preferably has a certain size. Since the third hole h3c has a perfect circular shape having a larger diameter than the second holes h2, light reflection at the side surface of the third hole h3c is enabled, and the brightness of the outer surface close to the light source 60 can be suitably suppressed.

In addition, when light is incident on the inside of the third hole h3c from the side surface of the third hole h3c, the light is diffused inside the third hole h3c, and thus an effect of suppressing the bright spots can be obtained. Thus, the brightness distribution can be adjusted by changing the arrangement of the third hole h3c.

Note that the shape of the third hole h3c is not limited to a perfect circular shape, but may be an elliptical shape. In this case, the elliptical shape is preferably disposed so as to leave the clearance between the first hole h1 and the third hole h3c and the clearance between the second holes h2 and the third hole h3c.

Further, the third hole h3c may be a hole having a larger area in plan view than the second holes h2 and have a shape other than a perfect circular shape or an elliptical shape, for example, a part of an elliptical shape. Otherwise, the third hole h3c may have a shape having a chord and an arc like the above-described third hole h3b, or may have another closed curved shape.

Note that, in this embodiment, the second holes h2 have a perfect circular shape, and the diameter is preferably in a range of 1.0 to 3.0 mm. Thus, it is possible to achieve the fluidity of resin at the time of resin molding while suitably suppressing uneven brightness.

In addition, the clearance between the adjacent second holes h2 is preferably 1.5 to 2.0 mm. Thus, it is possible to achieve the fluidity of resin at the time of resin molding while suitably suppressing uneven brightness.

The clearance between the first holes h1, the second holes h2, and the third holes h3 is preferably 1.5 mm or more, for example, 1.5 to 2.0 mm. Thus, it is possible to achieve the fluidity of resin at the time of resin molding while suitably suppressing uneven brightness.

In this embodiment, the third hole h3c has a perfect circular shape, and the diameter is preferably in a range of 3.0 mm to 6.0 mm. This suitably enables light reflection at the side surface of the third hole h3c.

Next, the fourth hole h4 formed in the plate portion 53a will be described.

The light-guiding member 53 includes the fourth hole h4 that is provided in the center of the plate portion 53a and that forms an opening larger than the first holes h1, the second holes h2, and the third holes h3.

As a result, as indicated by solid line arrows and broken line arrows in FIG. 26, it can be expected that light reflected by the side surface of the third hole h3 or the second hole h2 and returning toward the center of the plate portion 53a is reflected by the side surface of the fourth hole h4 and travels toward the outer surface far from the light source 60, that is, the outer surface the brightness of which is likely to decrease.

Next, other features of the cover unit 45 according to this embodiment, that is, the light-emitting device will be described.

The light-guiding member 53 includes the outer wall portion 53b that forms the peripheral edges E and that stands in a direction intersecting the surface of the plate portion 53a, specifically, in the +Z direction.

Light that has been emitted by the light sources 60 exits from the outer wall portion 53b, and thus the emitted light can be visually recognized not only from the side but also from the above, which improves visibility.

As illustrated in FIGS. 19 and 27, a groove portion 53c that reflects light traveling toward the outside of the plate portion 53a and that guides the light to the top portion of the outer wall portion 53b is formed at the outside of the outer wall portion 53b. Solid line arrows and broken line arrows in FIG. 27 indicate how light traveling toward the outside of the plate portion 53a is reflected by the groove portion 53c and travels toward the top portion of the outer wall portion 53b. Thus, it is possible to obtain the brightness of the outer wall portion 53b.

As illustrated in FIGS. 11 and 17, the cover unit 45 has a configuration in which the holder 56, which is an example of a light-shielding member, is provided inside the outer wall portion 53b and above the plate portion 53a, so that the outer wall portion 53b emits light in a ring shape.

This makes uneven brightness less conspicuous than in a configuration in which the entire light-guiding member 53 serves as a light-emitting part.

In addition, in the substrate 51 provided with the light sources 60 in this embodiment, a surface provided with the light sources 60 is formed as a reflection surface that reflects light. Thus, it is possible to suppress loss of light emitted from the light sources 60 and suitably cause light to exit from the light-guiding member 53.

Note that the reflection surface can be formed of a mirror surface or a white surface, for example.

Note that, in this embodiment, as illustrated in FIGS. 17 and 20, the area of the substrate 51 is smaller than the area of the plate portion 53a of the light-guiding member 53. Thus, it is also preferable to extend the reflection surface of the substrate 51 in the planar direction and place a reflection sheet or the like so as to cover the lower surface of the plate portion 53a.

In addition, in this embodiment, the cover unit 45 includes the reflection sheet 54 that reflects light as described with reference to FIG. 17. The substrate 51 and the reflection sheet 54 are provided on the opposite sides of the plate portion 53a of the light-guiding member 53. As an example, the reflection sheet 54 is formed to be large enough to cover the upper surface of the plate portion 53a. Thus, it is possible to suppress loss of light emitted from the light sources 60 and suitably cause light to exit from the light-guiding member 53.

Further, since the light-shielding sheet 55 is provided between the reflection sheet 54 and the holder 56, it is possible to suppress transmission of light through the holder 56. Note that, as an example, the light-shielding sheet 55 is formed to be as large as the reflection sheet 54.

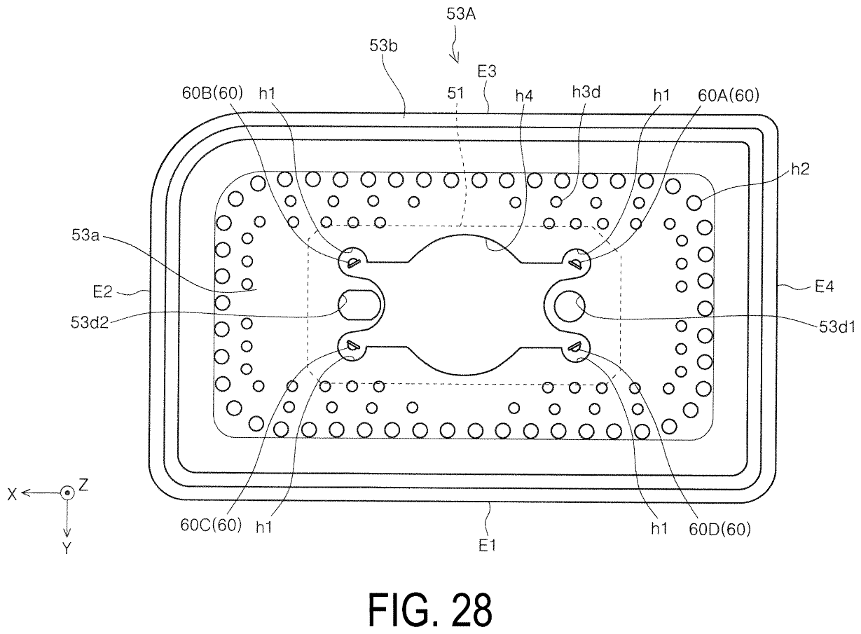

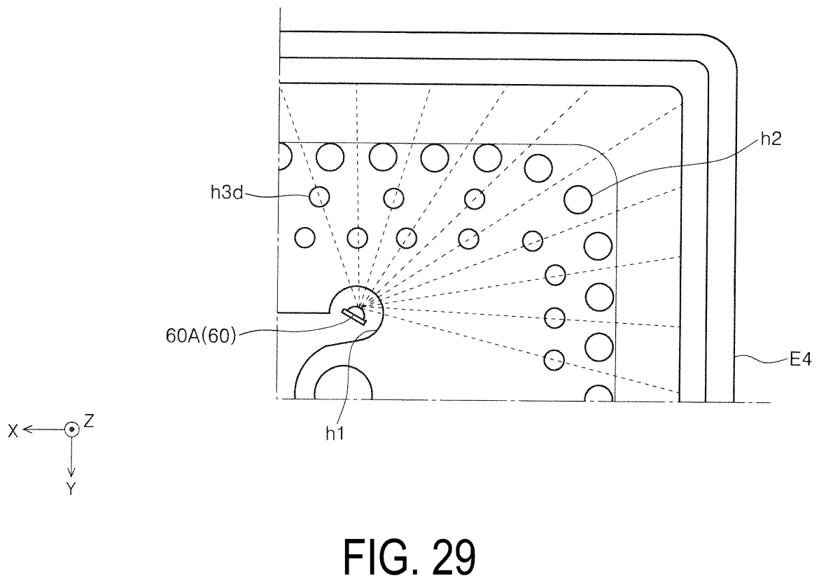

Next, a light-guiding member 53A according to another embodiment will be described with reference to FIGS. 28 and 29. Note that the same components as those already described are denoted by the same reference signs in FIGS. 28 and 29, and redundant description thereof will be omitted below.

The light-guiding member 53A includes third holes indicated by the reference sign h3d, instead of the third holes h3a, h3b, and h3c described above.

The third holes h3d have a perfect circular shape having a smaller diameter than second holes h2 and are disposed more inside than the second holes h2.

FIG. 29 is a partial enlarged view of FIG. 28, and each broken line is a straight line connecting an intermediate position between two adjacent second holes h2 and a light source 60. Note that the intermediate position between the two adjacent second holes h2 is an intermediate position of a line segment connecting the center position of one second hole h2 of the two adjacent second holes h2 and the center position of the other second hole h2. The third holes h3d are provided at positions intersecting the broken lines.

Thus, it is possible to exclude light directly traveling from the light source 60 toward peripheral edges E of the light-guiding member 53A and suppress a partial increase in the brightness.

Note that although it is preferable to dispose the third holes h3d such that the center positions of the third holes h3d are located on the broken lines, the third holes h3d are only required to intersect the broken lines.

Further, the third holes h3d may have the same diameter as the second holes h2 or may have a larger diameter than the second holes h2.

Further, the present disclosure is not limited to the above-described embodiments and modification examples, various modifications can be made within the scope of the disclosure as described in the appended claims, and it is needless to say that the modifications also fall within the scope of the disclosure.

For example, a configuration may be adopted in which the upper surface and the side surface of the cover unit 45 is transparent or semitransparent so that the ink supplying ports 19 inside the cover unit 45 can be seen.

In addition, in a configuration in which a corner portion close to the cover unit 45 among four corners of the document table 6 is used as a reference position at the time of setting a document, and a mark indicating that this corner portion is the reference position is provided at the frame member 7, the mark can be easily visually recognized even in a dark environment by causing the light-emitting unit 50 to emit light, and thus a document can be set easily. Note that, in this case, it is preferable to provide an opening and closing sensor for detecting that the document cover 8 or the document feeding device 9 is opened, cause the light-emitting unit 50 to emit light when the document cover 8 or the document feeding device 9 is opened, and cause the light-emitting unit 50 to be turned off when the document cover 8 or the document feeding device 9 is closed. It is also preferable to turn on only the light source 60 closest to the above reference position among the plurality of light sources 60, that is, the light source 60A in FIG. 10.

What is claimed is:

1. A light-emitting device comprising:
a light source; and
a light-guiding member on which light emitted by the light source is incident and from which the light incident exits to an outside, wherein
the light-guiding member includes
a plate portion having a planar shape,
a first hole provided in the plate portion, the first hole being a hole in which the light source is disposed, and
a plurality of second holes provided in the plate portion, the plurality of second holes being located between the first hole and a peripheral edge of the light-guiding member in plan view of the plate portion, the plurality of second holes being provided at intervals along the peripheral edge, and
the light source emits light toward a side surface of the first hole.

2. The light-emitting device according to claim 1, wherein
the light-guiding member includes a third hole provided in the plate portion, the third hole being located between the first hole and the plurality of second holes in plan view of the plate portion, and
in plan view of the plate portion, a line connecting the light source and a first part of the peripheral edge is defined as a first straight line, a line that connects the light source and a second part of the peripheral edge and that is a straight line shorter than the first straight line is defined as a second straight line, and the third hole is provided at a position intersecting the second straight line.

3. The light-emitting device according to claim 2, wherein
the light-guiding member includes a plurality of the third holes, and
at least one of the plurality of third holes has an elliptical shape such that a clearance from the first hole and clearances from the plurality of second holes increase.

4. The light emitting device according to claim 2, wherein
the light-guiding member includes a plurality of the third holes, and
at least one of the plurality of third holes has a shape obtained by cutting a part of a circle to have a chord and an arc, and the chord is disposed to face the first hole.

5. The light emitting device according to claim 2, wherein
the light-guiding member includes a plurality of the third holes, and
at least one of the plurality of third holes is a hole having an area larger than the plurality of second holes and has a circular shape, an elliptical shape, or a closed curved shape.

6. The light emitting device according to claim 2, wherein
the light-guiding member includes a fourth hole provided in a center of the plate portion, the fourth hole forming an opening larger than the first hole, the plurality of second holes, and the third hole.

7. The light-emitting device according to claim 1, wherein
the light-guiding member includes an outer wall portion forming the peripheral edge and standing in a direction intersecting a surface of the plate portion.

8. The light-emitting device according to claim 7, further comprising:
a groove portion formed on an outside of the outer wall portion, the groove portion being configured to reflect light traveling toward an outside of the plate portion and guide the light to a top portion of the outer wall portion.

9. The light-emitting device according to claim 7, further comprising:
a light-shielding member provided inside the outer wall portion and above the plate portion, wherein
the light-shielding member causes the outer wall portion to be configured to emit light in a ring shape.

10. The light-emitting device according to claim 1, further comprising:
a substrate provided with the light source, wherein
a surface, of the substrate, at which the light source is provided is formed as a reflection surface configured to reflect light.

11. The light-emitting device according to claim 1, further comprising:
a substrate provided with the light source and
a reflection sheet, the reflection sheet and the substrate being on opposite sides of the plate portion of the light-guiding member, the reflection sheet being configured to reflect light.

12. The light-emitting device according to claim 1, further comprising:
a filter provided between an inner surface of the first hole and the light source, the filter being configured to adjust a light emission color.

13. The light-emitting device according to claim 1, wherein
the light-guiding member is formed of an optically transparent material including a light-diffusing material.

14. The light-emitting device according to claim 1, wherein
a surface of the light-guiding member is subjected to embossing.

15. A liquid ejecting device comprising:
a device main body including a liquid ejecting head configured to eject a liquid to a medium; and
a liquid accommodating unit configured to accommodate the liquid to be ejected from the liquid ejecting head, wherein
the liquid accommodating unit includes
a supplying port of the liquid and
an opening and closing cover configured to be switched between a closed state in which the supplying port is covered and an open state in which the supplying port is exposed, and
the light-emitting device according to claim 1 is configured at the opening and closing cover and emits light in accordance with a remaining amount of the liquid accommodated in the liquid accommodating unit.
